(19) United States
(12) Patent Application Publication
(10) Pub. No.: US 2004/0252156 A1
(43) Pub. Date: Dec. 16, 2004

(54) Liquid ejecting apparatus

(75) Inventor: Tatsuya Seshimo, Nagano-Ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/813,623

(22) Filed: Mar. 31, 2004

(30) Foreign Application Priority Data
Mar. 31, 2003 (JP) 2003-96042
Mar. 15, 2004 (JP) 2004-73351

(51) Int. Cl. B41J 2/165

(52) U.S. Cl. 347/30

(57) ABSTRACT

A liquid ejecting apparatus includes: a head member having a nozzle and a liquid-ejecting unit; a main controlling part that drives the liquid-ejecting unit based on ejecting data; a capping member relatively movable between a position away from the head member and a position in contact with the head member; a suction way communicated with an inside of the capping member; and a built-in slide-rotator type of positive displacement pump provided in the suction way. A state-quantity recognizing part recognizes a state quantity related to a dry state in an inside of the positive displacement pump. A judging part judges whether the inside of the positive displacement pump is dry, by comparing the state quantity with a standard state quantity. A preliminary-operation carrying-out part carries out a preliminary operation for wetting the inside of the positive displacement pump, when the inside of the positive displacement pump is dry.

### FIELD OF THE INVENTION

This invention relates to a liquid ejecting apparatus having a head member capable of ejecting a drop of liquid from a nozzle.

### BACKGROUND OF THE INVENTION

Generally, an ink-jetting recording apparatus, which is an example of liquid ejecting apparatus, includes a recording head having a nozzle, an ink-jetting means for ejecting ink from the nozzles (for example, a piezoelectric vibrating member or a heat-generating member), and a main controlling part that controls the ink-jetting means based on recording data.

The nozzle of the recording head may be clogged with thickened ink. In order to prevent clogging of the nozzle with the thickened ink, the thickened ink may be forcibly sucked from the nozzle.

Tube pumps are commonly used for forcibly sucking the thickened ink. In a tube pump, a tube is collapsed by a pulley, and then returns to an original shape of the tube due to rigidity thereof. The latter volume change provides a suction power.

However, the rigidity of the tube may change depending on temperature change or the like, so that suction speed may also change undesirably. In addition, in order to increase a volume of sucked ink, it is effective to raise a rotation speed of the pulley. However, there is no effect if the pulley is rotated at a speed faster than that at which the collapsed tube returns to the original shape. That is, the volume of sucked ink can not be increased greatly, In addition, if the diameter of the tune is increased, the volume of sucked ink may be increased. However, in that case, the thickness of the tube has to be increased in order to maintain the rigidity of the tube, which results in the lager sucking system.

The inventor has paid attention to a built-in slide-rotator type of positive displacement pump, because it is easy to downsize and optimally design the built-in slide-rotator type of positive displacement pump depending on a driving rotational speed and/or a required flow rate.

However, in the built-in slide-rotator type of positive displacement pump, there is the following problem, that is, when the inside of the positive displacement pump comes to nearly a dry state due to a long disuse or the like, the seal tightness between the pump frame (casing) and the slide-rotator (gear or the like) may be weakened so that the suction power may be considerably reduced.

JP Laid-Open Publication No. 55-64178 discloses a technique wherein a wetting agent is injected from outside into between a seal ring and a seal plate before driving a gear pump (an example of built-in slide-rotator type of positive displacement pump), when a kind of heated liquid is conveyed by the gear pump.

However, it is necessary to inject the wetting agent into the built-in slide-rotator type of positive displacement pump only when the inside comes to nearly a dry state. That is, if the wetting agent is injected in the built-in slide-rotator type of positive displacement pump always before driving the positive displacement pump, the wetting agent may be wasted in surplus. This is not preferable.

### SUMMARY OF THE INVENTION

The object of this invention is to solve the above problems, that is, to provide a liquid ejecting apparatus including a built-in slide-rotator type of positive displacement pump wherein the inside of the positive displacement pump can be efficiently returned from a dry state to a wet state.

In this specification and claims, the “wet state” in the inside of the positive displacement pump means a state capable of providing a negative pressure equal to or greater than −5 kPa, preferably −15 kPa, by means of an operation of the positive displacement pump.

In order to achieve the object, the invention is a liquid ejecting apparatus comprising: a head member having a nozzle and a liquid-ejecting unit that ejects liquid in the nozzle; a main controlling part that drives the liquid-ejecting unit based on ejecting data; a capping member relatively movable between a position away from the head member and a position in contact with the head member; a suction way communicated with an inside of the capping member; a built-in slide-rotator type of positive displacement pump provided in the suction way; a state-quantity recognizing part that recognizes a state quantity related to a dry state in an inside of the built-in slide-rotator type of positive displacement pump; a standard-state-quantity setting part in which a standard state quantity is set, the standard state quantity being a standard for carrying out a preliminary operation for wetting the inside of the positive displacement pump; a judging part that judges whether the inside of the positive displacement pump is dry or not, by comparing the state quantity recognized by the state-quantity recognizing part with the standard state quantity set in the standard-state-quantity setting part; and a preliminary-operation carrying-out part that carries out the preliminary operation for wetting the inside of the positive displacement pump, when it is judged by the judging part that the inside of the positive displacement pump is dry.

According to the above feature, since the preliminary operation for wetting the inside of the positive displacement pump is carried out only when it is judged that the inside of the positive displacement pump is dry, the inside of the positive displacement pump can be efficiently returned from a dry state to a wet state.

Alternatively, the invention is a liquid ejecting apparatus comprising: a head member having a nozzle and a liquid-ejecting unit that ejects liquid in the nozzle; a main controlling part that drives the liquid-ejecting unit based on ejecting data; a capping member relatively movable between a position away from the head member and a position in contact with the head member; a suction way communicated with an inside of the capping member; a built-in slide-rotator type of positive displacement pump provided in the suction way; a state-quantity recognizing part that recognizes a state quantity related to a dry state in an inside of the built-in slide-rotator type of positive displacement pump; a standard-state-quantity setting part in which a standard state quantity is set, the standard state quantity being a standard for carrying out a preliminary operation for wetting the inside of the positive displacement pump; a judging part that judges whether the inside of the positive displacement pump is dry or not, by comparing the state quantity recognized by the state-quantity recognizing part with the standard state quantity set in the standard-state-quantity setting part; a displaying part that displays judge result by the judging part; an inputting part into which a preliminary-operation instruction is manually inputted; and a preliminary-operation carrying-out part that carries out the preliminary operation for wetting the inside of the positive displacement pump, based on the preliminary-operation instruction inputted into the inputting part.

According to the above feature, when it is judged that the inside of the positive displacement pump is dry, the judge result is displayed by the displaying unit, so that an operator (user) can estimate or notice a dry state in the inside of the positive displacement pump. This makes it possible to efficiently carry out the preliminary operation for wetting the inside of the positive displacement pump.

For example, the preliminary-operation carrying-out part is adapted to cause the liquid-ejecting unit to eject liquid from the nozzle into the capping member, and thereafter drive the built-in slide-rotator type of positive displacement pump for a predetermined preliminary-operation time.

In the case, by means of the liquid ejected by the liquid-ejecting unit, the built-in slide-rotator type of positive displacement pump is efficiently returned to a wet state. Thus, it is unnecessary to prepare a special wetting agent. In addition, it is unnecessary to provide another mechanism for introducing a wetting agent, that is, the structure is simpler.

Alternatively, the built-in slide-rotator type of positive displacement pump may have a pump frame connected to the suction way, and a wetting-agent supplying way for supplying a wetting agent may be connected to the pump frame. In the case, it is preferable that the preliminary-operation carrying-out part is adapted to supply the wetting agent into the pump frame via the wetting-agent supplying way. In the case, an optimum wetting agent can be supplied at an optimum flow rate.

For example, if a priming pump is provided in the wetting-agent supplying way, it is preferable that the preliminary-operation carrying-out part is adapted to supply the wetting agent into the pump frame by causing the priming pump to operate.

In addition, if the head member is integrated with a pushing member, and the pushing member is movable in a direction in such a manner that the pushing member can push the priming pump to cause the priming pump to operate, it is preferable that the preliminary-operation carrying-out part is adapted to supply the wetting agent into the pump frame by causing the priming pump to operate via the pushing member by moving the head member.

Alternatively, the invention is a liquid ejecting apparatus comprising: a head member having a nozzle and a liquid-ejecting unit that ejects liquid in the nozzle; a main controlling part that drives the liquid-ejecting unit based on ejecting data; a capping member relatively movable between a position away from the head member and a position in contact with the head member; a suction way communicated with an inside of the capping member; a built-in slide-rotator type of positive displacement pump provided in the suction way; a state-quantity recognizing part that recognizes a state quantity related to a dry state in an inside of the built-in slide-rotator type of positive displacement pump; a standard-state-quantity setting part in which a standard state quantity is set, the standard state quantity being a standard for carrying out a preliminary operation for wetting the inside of the positive displacement pump; a judging part that judges whether the inside of the positive displacement pump is dry or not, by comparing the state quantity recognized by the state-quantity recognizing part with the standard state quantity set in the standard-state-quantity setting part; and a displaying part that displays judge result by the judging part; wherein the built-in slide-rotator type of positive displacement pump has a pump frame connected to the suction way; a wetting-agent supplying way for supplying a wetting agent is connected to the pump frame; a priming pump is provided in the wetting-agent supplying way; and a manual inputting part for causing the priming pump to operate is connected to the priming pump.

According to the above feature, when it is judged that the inside of the positive displacement pump is dry, the judge result is displayed by the displaying unit, so that an operator (user) can estimate or notice a dry state in the inside of the positive displacement pump. This makes it possible to efficiently cause the priming pump to operate for wetting the inside of the positive displacement pump.

For example, the state quantity related to a dry state in an inside of the built-in slide-rotator type of positive displacement pump is a non-operating time of the positive displacement pump. In the case, the state-quantity recognizing part is a non-operating-time recognizing part that recognizes the non-operating time, the standard state quantity being a standard for carrying out a preliminary operation is a standard time being a standard for carrying out a preliminary operation, the standard-state-quantity setting part is a standard-time setting part in which the standard time is set, and the judging part is adapted to judge that the inside of the positive displacement pump is dry, when the non-operating time recognized by the non-operating-time recognizing part is equal to or longer than the standard time set in the standard-time setting part.

Alternatively, the state quantity related to a dry state in an inside of the built-in slide-rotator type of positive displacement pump may be a continuous open time of the capping member or an elapsed time in an OFF state of an electric power source.

Alternatively, the state quantity related to a dry state in an inside of the built-in slide-rotator type of positive displacement pump may be a state quantity related to an operating state of the positive displacement pump after the positive displacement pump has been driven for a predetermined time.

Specifically, for example, the state quantity related to an operating state of the positive displacement pump is a pressure in the capping member after the positive displacement pump has been driven for a predetermined time. If the pressure in the capping member after the positive displacement pump has been driven for a predetermined time doesn't reach a predetermined negative pressure, it can be estimated that the inside of the positive displacement pump is in a dry state. In the case, the state-quantity recognizing part is a pressure detecting part that recognizes the pressure in the capping member, the standard state quantity being a standard for carrying out a preliminary operation is a standard negative pressure being a standard for carrying out a preliminary operation, the standard-state-quantity setting part is a standard-negative-pressure setting part in which the standard negative pressure is set, and the judging part is adapted to judge that the inside of the positive displacement pump is dry, when the pressure in the capping member recognized by the pressure detecting part is equal to or above the standard negative pressure set in the standard-negative-pressure setting part. A film sensor or the like provided in a liquid way may be used as the pressure detecting part.

Alternatively, the state quantity related to an operating state of the positive displacement pump may be a state quantity related to a liquid flow after the positive displacement pump has been driven for a predetermined time. If an expected liquid flow isn't generated after the positive displacement pump has been driven for a predetermined time, it can be estimated that the inside of the positive displacement pump is in a dry state. The state quantity related to a liquid flow may be detected by a photon-interrupter provided in a liquid way, or an electrode provided in the capping member or the positive displacement pump, or the like. In addition, a liquid flow into the pump may be detected, by detecting change in a rotational load of a motor for driving the pump from an electrical current waveform of the motor.

Herein, the built-in slide-rotator type of positive displacement pump means any pump including: a casing member, at least one rotator consisting of one or more parts, and a power transfer device for rotating the rotator, wherein a pump action is achieved by volume change caused by rotation of the rotator in the casing member. For example, the built-in slide-rotator type of positive displacement pump may be any gear pump, any roots pump, any quimby screw pump, any vane pump, or the like.

In addition, the concept of the present invention can be also applied to cases using a reciprocating-mechanism type of positive displacement pump instead of the built-in slide-rotator type of positive displacement pump. That is, the invention is a liquid ejecting apparatus comprising: a head member having a nozzle and a liquid-ejecting unit that ejects liquid in the nozzle; a main controlling part that drives the liquid-ejecting unit based on ejecting data; a capping member relatively movable between a position away from the head member and a position in contact with the head member; a suction way communicated with an inside of the capping member; a reciprocating-mechanism type of positive displacement pump provided in the suction way; a state-quantity recognizing part that recognizes a state quantity related to a dry state in an inside of the reciprocating-mechanism type of positive displacement pump; a standard-state-quantity setting part in which a standard state quantity is set, the standard state quantity being a standard for carrying out a preliminary operation for wetting the inside of the positive displacement pump; a judging part that judges whether the inside of the positive displacement pump is dry or not, by comparing the state quantity recognized by the state-quantity recognizing part with the standard state quantity set in the standard-state-quantity setting part; and a preliminary-operation carrying-out part that carries out the preliminary operation for wetting the inside of the positive displacement pump, when it is judged by the judging part that the inside of the positive displacement pump is dry.

According to the above feature, since the preliminary operation for wetting the inside of the positive displacement pump is carried out only when it is judged that the inside of the positive displacement pump is dry, the inside of the positive displacement pump can be efficiently returned from a dry state to a wet state.

Alternatively, the invention is a liquid ejecting apparatus comprising: a head member having a nozzle and a liquid-ejecting unit that ejects liquid in the nozzle; a main controlling part that drives the liquid-ejecting unit based on ejecting data; a capping member relatively movable between a position away from the head member and a position in contact with the head member; a suction way communicated with an inside of the capping member; a reciprocating-mechanism type of positive displacement pump provided in the suction way; a state-quantity recognizing part that recognizes a state quantity related to a dry state in an inside of the reciprocating-mechanism type of positive displacement pump; a standard-state-quantity setting part in which a standard state quantity is set, the standard state quantity being a standard for carrying out a preliminary operation for wetting the inside of the positive displacement pump; a judging part that judges whether the inside of the positive displacement pump is dry or not, by comparing the state quantity recognized by the state-quantity recognizing part with the standard state quantity set in the standard-state-quantity setting part; a displaying part that displays judge result by the judging part; an inputting part into which a preliminary-operation instruction is manually inputted; and a preliminary operation carrying-out part that carries out the preliminary operation for wetting the inside of the positive displacement pump, based on the preliminary-operation instruction inputted into the inputting part.

According to the above feature, when it is judged that the inside of the positive displacement pump is dry, the judge result is displayed by the displaying unit, so that an operator (user) can estimate or notice a dry state in the inside of the positive displacement pump. This makes it possible to efficiently carry out the preliminary operation for wetting the inside of the positive displacement pump.

For example, the preliminary-operation carrying-out part is adapted to cause the liquid-ejecting unit to eject liquid from the nozzle into the capping member and thereafter drive the reciprocating-mechanism type of positive displacement pump for a predetermined preliminary-operation time.

In the case, by means of the liquid ejected by the liquid-ejecting unit, the reciprocating-mechanism type of positive displacement pump is efficiently returned to a wet state. Thus, it is unnecessary to prepare a special wetting agent. In addition, it is unnecessary to provide another mechanism for introducing a wetting agent, that is, the structure is simpler.

Alternatively, the reciprocating-mechanism type of positive displacement pump may have a pump frame connected to the suction way, and a wetting-agent supplying way for supplying a wetting agent may be connected to the pump frame. In the case, it is preferable that the preliminary-operation carrying-out part is adapted to supply the wetting agent into the pump frame via the wetting-agent supplying way. In the case, an optimum wetting agent can be supplied at an optimum flow rate.

For example, if a priming pump is provided in the wetting-agent supplying way, it is preferable that the preliminary-operation carrying-out part is adapted to supply the wetting agent into the pump frame by causing the priming pump to operate.

In addition, if the head member is integrated with a pushing member, and the pushing member is movable in a direction in such a manner that the pushing member can push the priming pump to cause the priming pump to operate, it is preferable that the preliminary-operation carrying-out part is adapted to supply the wetting agent into the pump frame by causing the priming pump to operate via the pushing member by moving the head member.

Alternatively, the invention is a liquid ejecting apparatus comprising: a head member having a nozzle and a liquid-ejecting unit that ejects liquid in the nozzle; a main controlling part that drives the liquid-ejecting unit based on ejecting data; a capping member relatively movable between a position away from the head member and a position in contact with the head member; a suction way communicated with an inside of the capping member; a reciprocating-mechanism type of positive displacement pump provided in the suction way; a state-quantity recognizing part that recognizes a state quantity related to a dry state in an inside of the reciprocating mechanism type of positive displacement pump; a standard-state-quantity setting part in which a standard state quantity is set, the standard state quantity being a standard for carrying out a preliminary operation for wetting the inside of the positive displacement pump; a judging part that judges whether the inside of the positive displacement pump is dry or not, by comparing the state quantity recognized by the state-quantity recognizing part with the standard state quantity set in the standard-state-quantity setting part; and a displaying part that displays judge result by the judging part; wherein the reciprocating-mechanism type of positive displacement pump has a pump frame connected to the suction way; a wetting-agent supplying way for supplying a wetting agent is connected to the pump frame; a priming pump is provided in the wetting-agent supplying way; and a manual inputting part for causing the priming pump to operate is connected to the priming pump.

According to the above feature, when it is judged that the inside of the positive displacement pump is dry, the judge result is displayed by the displaying unit, so that an operator (user) can estimate or notice a dry state in the inside of the positive displacement pump. This makes it possible to efficiently cause the priming pump to operate for wetting the inside of the positive displacement pump.

For example, the state quantity related to a dry state in an inside of the reciprocating-mechanism type of positive displacement pump is a non-operating time of the positive displacement pump. Alternatively, the state quantity related to a dry state in an inside of the reciprocating-mechanism type of positive displacement pump may be a continuous open time of the capping member or an elapsed time in an OFF state of an electric power source.

Alternatively, the state quantity related to a dry state in an inside of the reciprocating-mechanism type of positive displacement pump may be a state quantity related to an operating state of the positive displacement pump after the positive displacement pump has been driven for a predetermined time.

The reciprocating-mechanism type of positive displacement pump may be any piston pump, any bellows pump, any diaphragm pump, or the like.

Alternatively, the invention is a controlling unit for controlling a liquid ejecting apparatus including: a head member having a nozzle and a liquid-ejecting unit that ejects liquid in the nozzle; a main controlling part that drives the liquid-ejecting unit based on ejecting data; a capping member relatively movable between a position away from the head member and a position in contact with the head member; a suction way communicated with an inside of the capping member; and a built-in slide-rotator type of positive displacement pump provided in the suction way; the controlling unit comprising

a state-quantity recognizing part that recognizes a state quantity related to a dry state in an inside of the built-in slide-rotator type of positive displacement pump,

a standard-state-quantity setting part in which a standard state quantity is set, the standard state quantity being a standard for carrying out a preliminary operation for wetting the inside of the positive displacement pump,

a judging part that judges whether the inside of the positive displacement pump is dry or not, by comparing the state quantity recognized by the state-quantity recognizing part with the standard state quantity set in the stand-state-quantity setting part, and

a preliminary-operation carrying-out part that carries out the preliminary operation for wetting the inside of the positive displacement pump, when it is judged by the judging part that the inside of the positive displacement pump is dry.

Alternatively, the invention is a controlling unit for controlling a liquid ejecting apparatus including: a head member having a nozzle and a liquid-ejecting unit that ejects liquid in the nozzle; a main controlling part that drives the liquid-ejecting unit based on ejecting data; a capping member relatively movable between a position away from the head member and a position in contact with the head member; a suction way communicated with an inside of the capping member; and a reciprocating-mechanism type of positive displacement pump provided in the suction way; the controlling unit comprising

a state-quantity recognizing part that recognizes a state quantity related to a dry state in an inside of the reciprocating-mechanism type of positive displacement pump,

a standard-state-quantity setting part in which a standard state quantity is set, the standard state quantity being a standard for carrying out a preliminary operation for wetting the inside of the positive displacement pump,

a judging part that judges whether the inside of the positive displacement pump is dry or not, by comparing the state quantity recognized by the state-quantity recognizing part with the standard state quantity set in the standard-state-quantity setting part, and

a preliminary-operation carrying-out part that carries out the preliminary operation for wetting the inside of the positive displacement pump, when it is judged by the judging part that the inside of the positive displacement pump is dry.

A computer system can materialize the controlling units or any element of the above controlling units.

This invention includes a storage unit capable of being read by a computer, storing a program for materializing the controlling unit or the element in a computer system.

This invention also includes the program itself for materializing the controlling unit or the element in the computer system.

This invention includes a storage unit capable of being read by a computer, storing a program including a command for controlling a second program executed by a computer system including a computer, the program being executed by the computer system to control the second program to materialize the controlling unit or the element.

This invention also includes the program itself including the command for controlling the second program executed by the computer system including the computer, the program being executed by the computer system to control the second program to materialize the controlling unit.

The storage unit may be not only a substantial object such as a floppy disk or the like, but also a network for transmitting various signals.

In addition, the invention is a method of controlling a liquid ejecting apparatus including: a head member having a nozzle and a liquid-ejecting unit that ejects liquid in the nozzle; a main controlling part that drives the liquid-ejecting unit based on ejecting data; a capping member relatively movable between a position away from the head member and a position in contact with the head member; a suction way communicated with an inside of the capping member; and a built-in slide-rotator type of positive displacement pump provided in the suction way; the method comprising

a step of recognizing a state quantity related to a dry state in an inside of the built-in slide-rotator type of positive displacement pump,

a step of judging whether the inside of the positive displacement pump is dry or not, by comparing the state quantity related to a dry state in an inside of the built-in slide-rotator type of positive displacement pump with a standard state quantity that has been set in advance, and

a step of carrying out a preliminary operation for wetting the inside of the positive displacement pump, when it is judged that the inside of the positive displacement pump is dry.

Alternatively, the invention is a method of controlling a liquid ejecting apparatus including: a head having a nozzle and a liquid-ejecting unit that ejects liquid in the nozzle; a main controlling part that drives the liquid-ejecting unit based on ejecting data; a capping member relatively movable between a position away from the head member and a position in contact with the head member; a suction way communicated with an inside of the capping member; and a reciprocating mechanism type of positive displacement pump provided in the suction way; the method comprising

a step of recognizing a state quantity related to a dry state in an inside of the reciprocating-mechanism type of positive displacement pump,

a step of judging whether the inside of the positive displacement pump is dry or not, by comparing the state quantity related to a dry state in an inside of the reciprocating-mechanism type of positive displacement pump with a standard state quantity that has been set in advance, and

a step of carrying out a preliminary operation for wetting the inside of the positive displacement pump, when it is judged that the inside of the positive displacement pump is dry.

### BRIEF DESCRIPTION OF THE DRAWINGS

FIG. 1 is a schematic perspective view of an ink-jetting recording apparatus of a first embodiment according to the invention;

FIG. 2A is a schematic view for explaining a scanning range of a recording head when the ink-recording apparatus conducts a single-direction (one-way) printing;

FIG. 2B is a schematic view for explaining a scanning range of a recording head when the ink-recording apparatus conducts a double-direction (forth and back) printing;

FIG. 3A is a schematic view for explaining a movement of the recording head, the recording head being located at a waiting position;

FIG. 3B is a schematic view for explaining the movement of the recording head, the recording head being moved from the waiting position to an objective recording area;

FIG. 3C is a schematic view for explaining the movement of the recording head, the recording head being moved back from the objective recording area to the waiting position;

FIG. 3D is a schematic view for explaining the movement of the recording head, the recording head being located at a home position;

FIG. 4A is a schematic sectional view of a capping member in the embodiment wherein an opening valve is opened;

FIG. 4B is a schematic sectional view of the capping member in the embodiment wherein the opening valve is closed;

FIG. 5A is a perspective view of a gear pump in the embodiment;

FIG. 5B is an exploded view of the gear pump;

FIG. 5C is a partial sectional view of the gear pump;

FIG. 6 is a sectional view of a head unit included in the recording head;

FIG. 7 is a schematic block diagram for explaining an electric structure of the ink-jetting recording apparatus of the embodiment;

FIG. 8 is a flow chart showing a preliminary operation for the gear pump;

FIG. 9 is a schematic sectional view of a gear pump and periphery thereof in an ink-jetting recording apparatus of a second embodiment according to the invention;

FIG. 10A is a schematic side view of a recording head, a capping member and a priming pump of the second embodiment wherein the recording head is located at a flushing position;

FIG. 10B is a schematic side view of the recording head, the capping member and the priming pump wherein the recording head is located at a capping position;

FIG. 10C is a schematic side view of a recording head, a capping member and a priming pump wherein the recording head is located at a priming-pump pushing position;

FIG. 11 is a flow chart showing a preliminary operation for a gear pump of the second embodiment;

FIG. 12 is a schematic block diagram for explaining an electric structure of an ink-jetting recording apparatus of a third embodiment according to the invention;

FIG. 13 is a schematic block diagram for explaining an electric structure of an ink-jetting recording apparatus of a fourth embodiment according to the invention;

FIG. 14 is a schematic block diagram for explaining an electric structure of an ink-jetting recording apparatus of a fifth embodiment according to the invention;

FIG. 15 is a flow chart showing a preliminary operation for a gear pump of the fifth embodiment;

FIG. 16A is a perspective view of a roots pump;

FIG. 16B is an exploded view of the roots pump;

FIG. 16C is a plan view of the roots pump from which a lid is removed;

FIG. 17A is a perspective view of a quimby screw pump;

FIG. 17B is an exploded view of the quimby screw pump;

FIG. 17C is a partial sectional view of the quimby screw pump;

FIG. 18A is a perspective view of a vane pump;

FIG. 18B is an exploded view of the vane pump;

FIG. 18C is a plan view of the vane pump from which a lid is removed;

FIG. 19A is a schematic sectional view of a capping member in an embodiment wherein an opening valve is opened, the embodiment including a check valve between the capping member and a pump frame;

FIG. 19B is a schematic sectional view of the capping member in the embodiment wherein the opening valve is closed;

FIG. 20 is a schematic sectional view of a piston pump;

FIG. 21 is a schematic sectional view of a bellows pump; and

FIG. 22 is a schematic sectional view of a diaphragm pump.

### BEST MODE FOR CARRYING OUT THE INVENTION

Embodiments of the invention will now be described in more detail with reference to drawings.

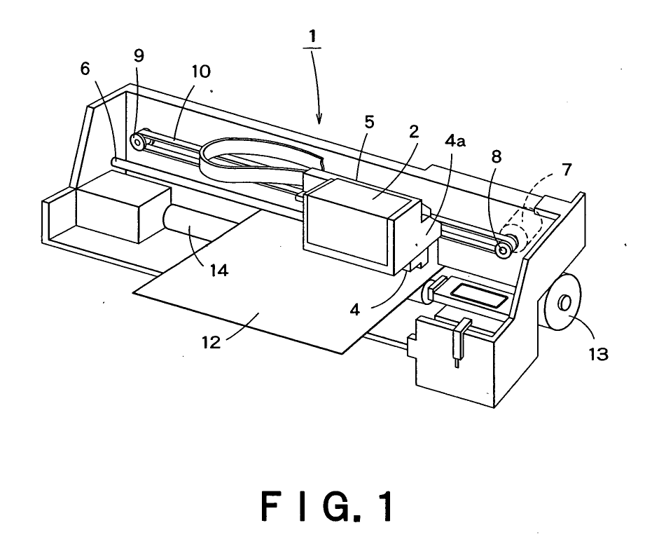

FIG. 1 is a schematic perspective view of an ink-jetting printer 1 as a liquid ejecting apparatus of a first embodiment according to the invention. The ink-jetting printer 1 includes a carriage 5 supporting a recording head 4 (head member) that has a cartridge holder 4a capable of holding an ink cartridge 2 (liquid container). The carriage 5 is adapted to be reciprocated in a main scanning direction by a head-scanning mechanism.

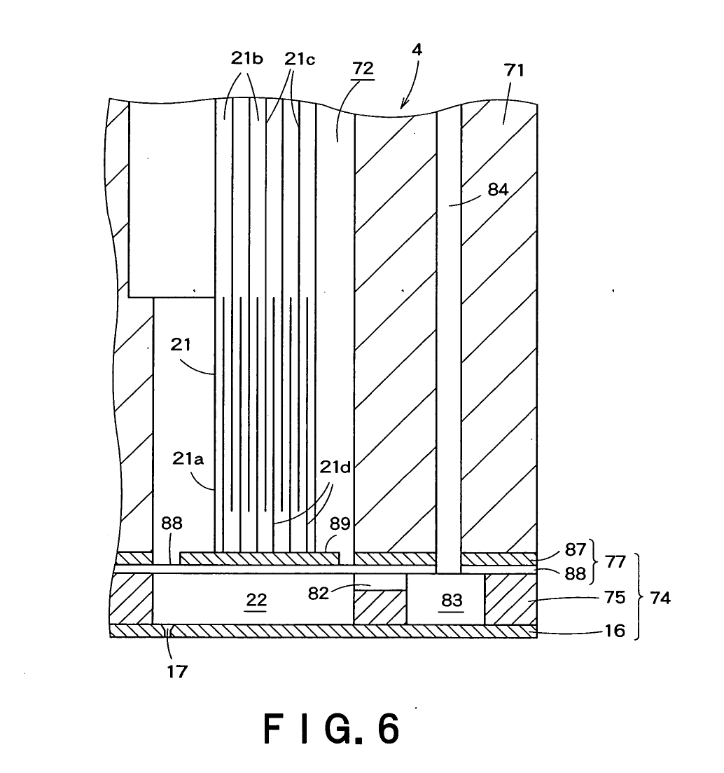

The head-scanning mechanism is formed by: a guide bar 6 horizontally extending in a housing, a pulse motor 7 arranged at a right portion of the housing, a driving pulley 8 connected to a rotational shaft of the pulse motor 7, a free pulley 9 mounted at a left portion of the housing, a timing belt 10 connected to the carriage 5 and going around the driving pulley 8 and the free pulley 9, and a controller 11 (see FIG. 6) for controlling the pulse motor 7. Thus, the carriage 5 i.e. the recording head 4 can be reciprocated in the main scanning direction i.e. in a width direction of a recording paper 12, by driving the pulse motor 7.

The printer 1 includes a paper feeding mechanism for feeding the recording paper 12 or any other recording medium (a medium onto which the ink (liquid) is jetted (ejected)) in a feeding direction (sub-scanning direction). The paper feeding mechanism consists of a paper feeding motor 13, a paper feeding roller 14 or the like. The recording paper 12, which is an example of a recording medium, is fed in a subordinate scanning direction in turn by the paper feeding mechanism, in cooperation with the recording operation of the recording head 4.

The printer 1 is adapted to conduct a recording operation when the recording head 4 is moved forth (single-direction recording).

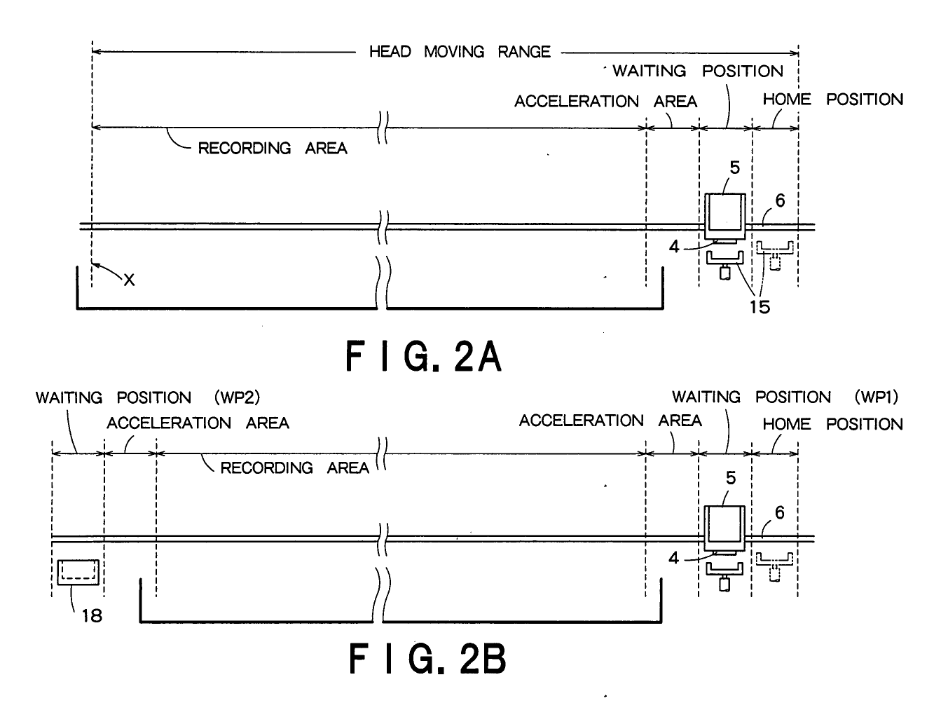

A home position and a waiting position of the recording head 4 (carriage 5) are set in a scanning range of the carriage 5 and in an end area outside an objective recording area. As shown in FIG. 2A, the home position is set at an end portion (a right end portion in FIG. 2A) in the scanning range of the recording head 4. The waiting position is set substantially adjacently to the home position on a side of the objective recording area.

This invention can be applied to a printer that is adapted to conduct a recording operation when the recording head 4 is move back as well when the recording head 4 is moved forth (double-direction recording). In such a printer, as shown in FIG. 2B, a second waiting position WP2 may be set at an opposite end portion with respect to a home position, in addition to a first waiting position WP1 substantially adjacent to the home position.

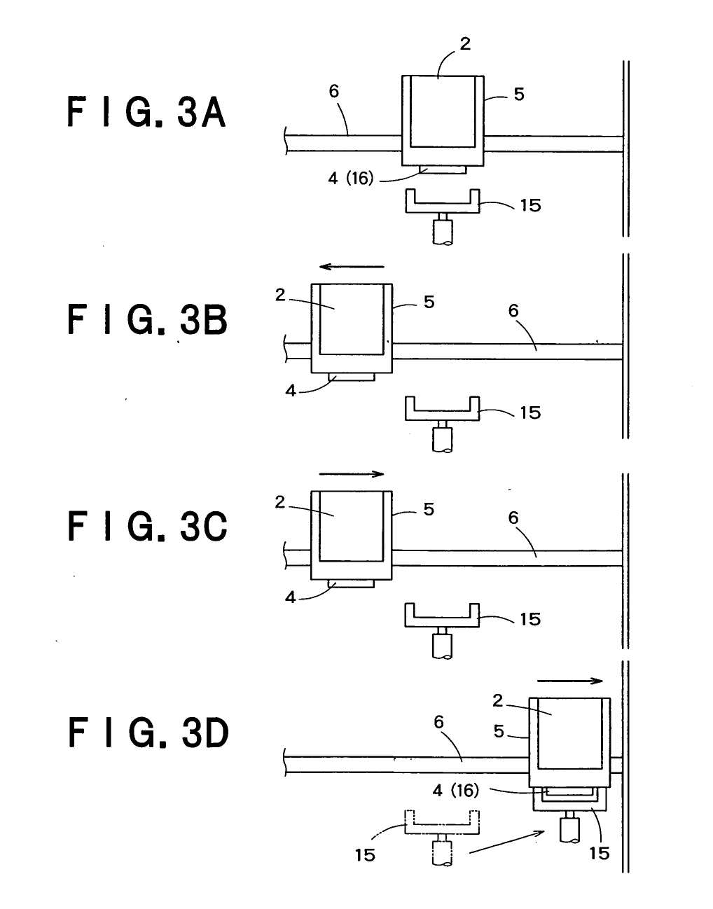

The home position is a position that the recording head 4 is moved to and stays at when electric power supply is off or when a long time has passed since the last recording operation. When the recording head 4 stays at the home position, as shown in FIG. 3D, a capping member 15 of the capping mechanism comes in contact with a nozzle plate 16 (see FIG. 6) and substantially seals nozzles 17 (see FIG. 6), which is described below in detail. The capping member 15 is a tray-like member having a substantially square shape, being open upward, and made of an elastic material such as a rubber. A moisture retaining material such as felt is attached inside the capping member 15. When the recording head 4 is sealed by the capping member 15, an inside of the capping member 15 is kept in high humid condition. Thus, it can be prevented that solvent of the ink evaporates from the nozzles 17.

The waiting position is a starting position for moving the recording head 4 in the main scanning direction. That is, normally, the recording head 4 stays and waits at the waiting position. When a recording operation is started, the recording head 4 is moved from the waiting position to the objective recording area. Then, when the recording operation is completed, the recording head 4 is moved back to the waiting position.

In a case of the printer for the double-direction recording, with reference to FIG. 2B, the recording head 4 is moved forth from the first waiting position WP1 to the second waiting position WP2 through the objective recording area, while jetting one or more drops of ink to the objective recording area. After that, the recording head 4 stays and waits at the second waiting position WP2. Then, the recording head 4 is moved back from the second waiting position WP2 to the first waiting position WP1 through the objective recording area, while jetting one or more drops of ink to the objective recording area. After that, the recording head 4 stays and waits at the first waiting position WP1. After that, the recording operation during moved forth and the recording operation during moved back are repeated in turn.

An ink-receiving member may be arranged under the waiting position in order to collect ink discharged from the recording head 4 because of flushing operations (maintenance operations). In the embodiment, the capping member 15 functions as such an ink-receiving member. That is, as shown in FIG. 3A, the capping member 15 is usually located at a position under the waiting position of the recording head 4 (a little apart from the nozzle plate 16). Then, when the recording head 4 is moved to the home position, as shown in FIG. 3D, the capping member 15 is also moved diagonally upward to the home position and to the nozzle plate 16 in order to seal the nozzles 17.

In the case of the printer for the double-direction recording, as shown in FIG. 2B, a second ink-receiving member 18 may be arranged under the second waiting position WP2. The second ink-receiving member 18 may be a flushing box open upward i.e. toward the recording head 4.

In addition, in the embodiment, an acceleration area is set between the waiting position and the objective recording area. The acceleration area is an area for raising a scanning velocity of the recording head 4 to a predetermined velocity.

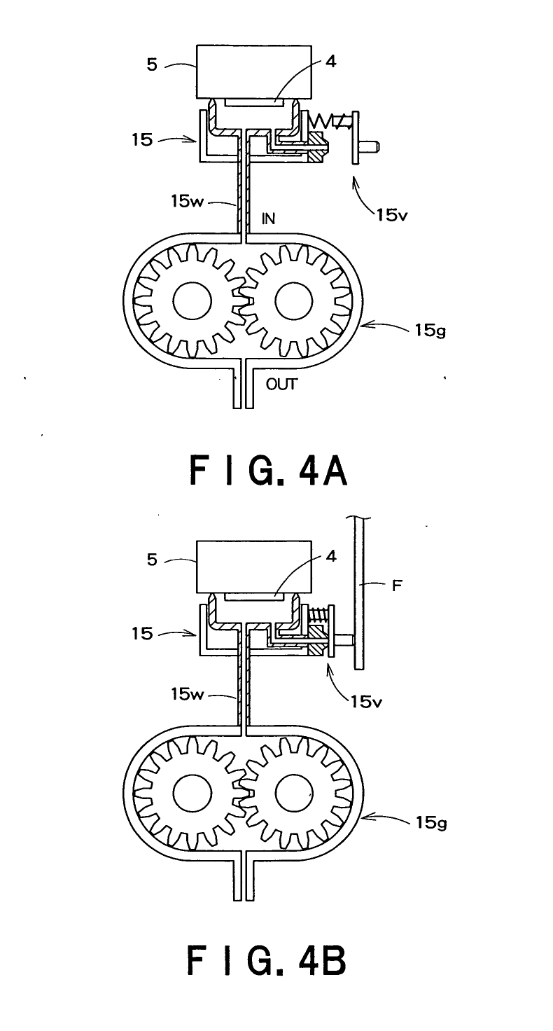

Herein, as shown in FIG. 4, a suction way 15w is extended from the capping member 15 of the embodiment. The suction way is communicated with the inside of the capping member 15. A gear pump 15g, which is a built-in slide-rotator type of positive displacement pump, is provided on the way of the suction way 15w. In the embodiment, the gear pump 15g is formed in such a precise manner that a gap between a gear and a pump frame (casing) is not more than 100 micron in both a radial direction and a thickness direction.

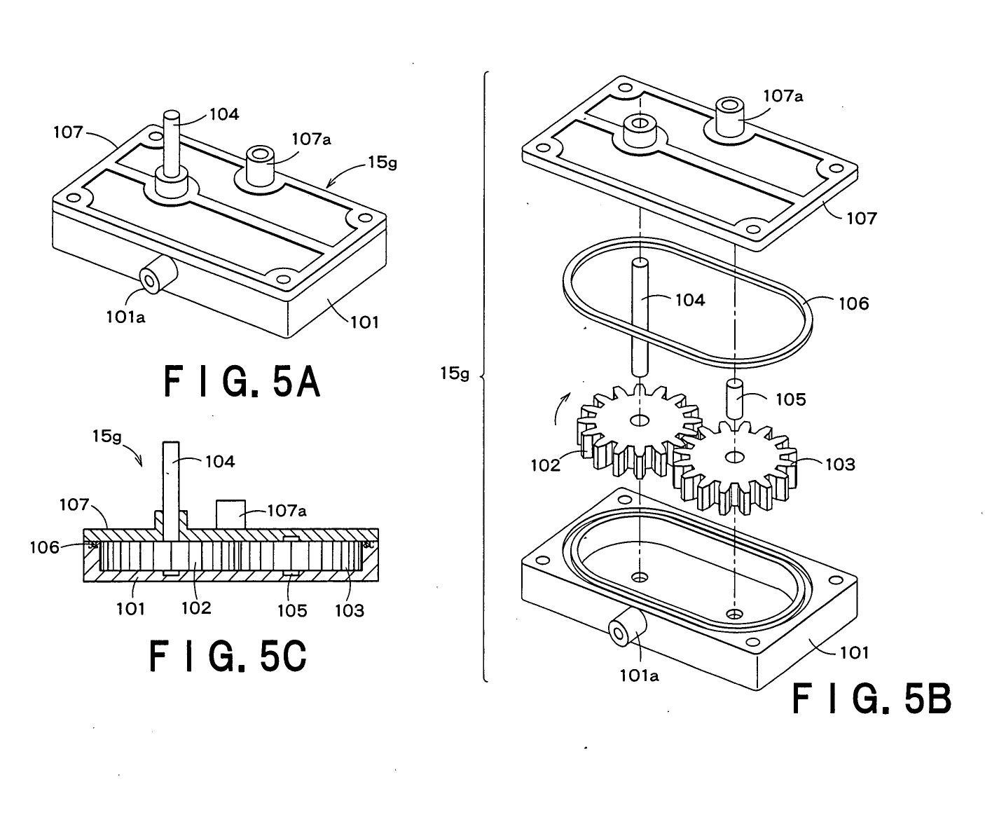

An example of structure of the gear pump 15g is explained in detail with reference to FIGS. 5A to 5C. FIG. 5A is a perspective view of the gear pump 15g, FIG. 5B is an exploded view of the gear pump 15g, and FIG. 5C is a partial sectional view of the gear pump 15.

As shown in FIGS. 5A to 5C, the gear pump 15g includes: a pump frame (casing) 151 having a suction port 151a connected to the suction way 15w; and a driving gear 152 and a driven gear 153 that are engaged with each other and slidably contained in the pump frame 151 with the above precision (via liquid (ink) menisci). The driving gear 152 is rotated by means of a driving gear shaft 154 that pierces the pump frame 151 and/or a lid 157. The driven gear 153 is pivotally supported by the pump frame 151 and the lid 157 via a driven gear shaft 155 that is parallel to the driving gear shaft 154. The pump frame (casing) 151 is sealed by the lid 157 via a packing 156. In the example, the lid 157 has a discharging port 157a. The suction port 151a and the discharging port 157a are located opposite with respect to a slide area between the gears 152, 153 and the pump frame 151.

When the driving gear 152 is rotated in a direction shown by an arrow in FIG. 5B by the driving gear shaft 154, the driven gear 153 engaged with the driving gear 152 is also rotated, so that the ink is conveyed from an IN area in the pump frame 151 (on the side of the suction port 151a) to an OUT area therein (on the side of the discharging port 157a) to achieve a pump function.

Herein, in the gear pump 15g, the seal at the engaging area and the casing area can not be released, even if the rotational direction of the gears is changed. That is, it is impossible for the In area and the OUT area to be communicated with each other to achieve an atmospheric release of the capping member 15. Therefore, the capping member 15 of the embodiment has a release-valve mechanism 15v that is normally open. The release-valve mechanism 15v has a small diameter. As shown in FIG. 4B, the release-valve mechanism 15v is adapted to close only when the capping member 15 comes in contact with a frame F or the like, correspondingly to when it is necessary to suck the ink.

Thus, the inside of the capping member 15 is normally communicated with the atmosphere, so that it is prevented the menisci are broken down by temperature change or the like, while the capping member 15 is suitably sealed when the ink has to be sucked.

Next, the inside mechanism of the recording head 4 is explained. The recording head 4 has: a black head unit capable of jetting a drop of black ink, a cyan head unit capable of jetting a drop of cyan ink, a magenta head unit capable of jetting a drop of magenta ink, a yellow head unit capable of jetting a drop of yellow ink, a light cyan head unit capable of jetting a drop of light cyan ink, and a light magenta head unit capable of jetting a drop of light magenta ink. Each head unit has a bottom surface on which the nozzles 17 are formed in the sub-scanning direction. The number of the nozzles 17 for each head unit is common, so that the nozzles 17 of the respective head units are also aligned in the main scanning direction.

The head units in the embodiment have substantially the same structure. As shown in FIG. 6, the head unit has a plastic box-like case 71 defining a housing room 72. The longitudinal-mode piezoelectric vibrating unit 21 has a shape of teeth of a comb, and is inserted in the housing room 72 in such a manner that points of teeth-like portions 21a of the piezoelectric vibrating unit 21 are aligned at an opening of the housing room 72. A ink-way unit 74 is bonded on a surface of the case 71 on the side of the opening of the housing room 72. The points of the teeth-like portions 21a are fixed at predetermined positions of the ink-way unit 74 to function as piezoelectric vibrating members respectively.

The piezoelectric vibrating unit 21 comprises a plurality of piezoelectric layers 21b. As shown in FIG. 6, common inside electrodes 21c and individual inside electrodes 21d are inserted alternately between each adjacent two of the piezoelectric layers 21b. The piezoelectric layers 21b, the common inside electrodes 21c and the individual inside electrodes 21d are integrated and cut into the shape of the teeth of the comb. Thus, when a voltage is provided between the common inside electrodes 21c and an individual inside electrode 21d, a piezoelectric vibrating member contracts in a longitudinal direction of each of the piezoelectric layers 21b.

The ink-way unit 74 consists of a nozzle plate 16, an elastic plate 77 and an ink-way forming plate 75 sandwiched between the nozzle plate 16 and the elastic plate 77. The nozzle plate 16, the ink-way forming plate 75 and the elastic plate 77 are integrated as shown in FIG. 6.

A plurality of nozzles 17 is formed in the nozzle plate 16. A plurality of pressure generating a 22, a plurality of supplying ways 82 and a common chamber 83 are formed in the ink-way forming plate 75. Each of the pressure chambers 22 is defined by partition walls, and is communicated with a corresponding nozzle 17 at an end portion thereof and with a corresponding supplying way 82 at the other end portion thereof. The common chamber 83 is communicated with all the supplying ways 82, and has a longitudinal shape. For example, the longitudinal common chamber 83 may be formed by an etching process when the ink-way forming plate 75 is a silicon wafer. Then, the pressure chambers 22 are formed in the longitudinal direction of the common chamber 83 at the same intervals (pitches) as nozzles 17. Then, a groove as an supplying way 82 is formed between each of the pressure chambers 22 and the common chamber 83. In the case, the supplying way 82 is connected to an end of the pressure chamber 22, while the nozzle 17 is located near the other end of the pressure chamber 22. The common chamber 83 is adapted to supply ink saved in the ink cartridge 2 to the pressure chambers 22. An supplying tube 84 from the ink cartridge is communicated with a middle portion of the common chamber 83.

The elastic plate 77 is layered on a surface of the ink-way forming plate 75 opposed to the nozzle plate 16. In the case, the elastic plate 77 consists of two laminated layers that are a stainless plate 87 and an elastic high-polymer film 88 such as a PPS film. The stainless plate 87 is provided with island portions 89 for fixing the teeth-like portions 21a as the piezoelectric vibrating members 21 in respective portions corresponding to the pressure chambers 22, by an etching process.

In the above head unit, a tooth-like portion 21a as a piezoelectric vibrating member can expand in the longitudinal direction. Then, an island portion 89 is pressed toward the nozzle plate 16, the elastic film 88 is deformed. Thus, a corresponding pressure chamber 22 contracts. On the other hand, the tooth-like portion 21a as the piezoelectric vibrating member can contract from the expanding state in the longitudinal direction. Then, the elastic film 88 is returned to the original state owing to elasticity thereof. Thus, the corresponding pressure chamber 22 expands. By causing the pressure chamber 22 to expand and then causing the pressure chamber 22 to contract, a pressure of the ink in the pressure chamber 22 increases so that the ink drop is jetted from a nozzle 17.

That is, in the above head unit, when a tooth-like portion 21a as a piezoelectric vibrating member is charged or discharged, the volume of the corresponding pressure chamber 22 is also changed. Thus, by using the change of the volume of the pressure chamber 22, the pressure of the ink in the pressure chamber 22 can be changed, so that a drop of the ink can be jetted from the corresponding nozzle 17 or a meniscus at the corresponding nozzle 17 can be minutely vibrated. The meniscus means a free surface of the ink exposed at an opening of the nozzle 17.

Instead of the above longitudinal-mode piezoelectric vibrating unit 21, bending-mode piezoelectric vibrating members can be used. When a bending-mode piezoelectric vibrating member is used, a charging operation causes a pressure chamber to contract, and a discharging operation causes the pressure chamber to expand.

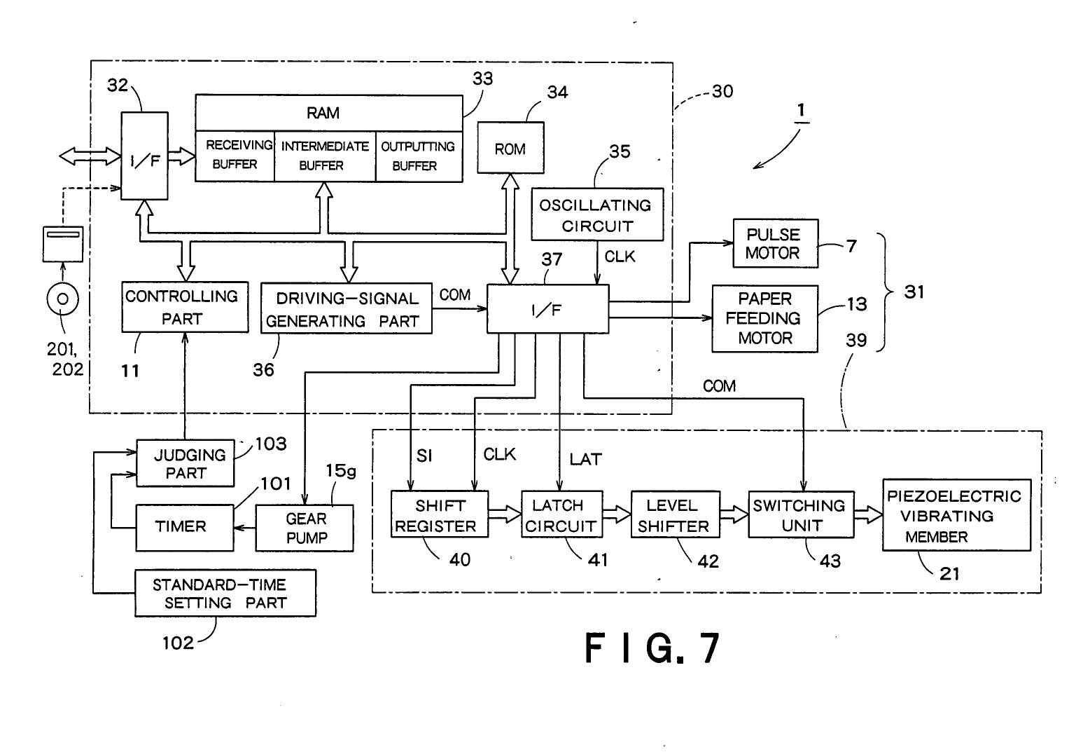

Then, an electric structure of the printer 1 is explained. As shown in FIG. 7, the ink-jetting printer 1 has a printer controller 30 and a printing engine 31.

The printer controller 30 has: an outside interface (outside I/F) 32, a RAM 33 which is able to temporarily store various data, a ROM 34 which stores a controlling program or the like, a controlling part 11 including CPU or the like, an oscillating circuit 35 for generating a clock signal, an driving-signal generating part 36 for generating an driving signal that is supplied into each head unit of the recording head 4, and an inside interface (inside I/F) 37 that is adapted to send the driving signal, dot-pattern-data (bit-map-data) developed according to printing data (jetting data) or the like to the print engine 31.

The outside I/F 32 is adapted to receive printing data consisting of character codes, graphic functions, image data or the like from a host computer not shown or the like. In addition, a busy signal (BUSY) or an acknowledge signal (ACK) is adapted to be outputted to the host computer or the like through the outside I/F 32.

In addition, the outside I/F 32 in the embodiment is connected to an interface unit 100 such as a keyboard, which may function as an input part into which information of dense-thin desire of a user about a “fully-covering” control may be inputted by the user.

The RAM 33 has a receiving buffer, an intermediate buffer, an outputting buffer and a work memory not shown. The receiving buffer is adapted to receive the printing data through the outside I/F 32, and temporarily store the printing data. The intermediate buffer is adapted to store intermediate-code-data converted from the printing data by the controlling part 11. The outputting buffer is adapted to store dot-pattern-data which are data for printing obtained by decoding (translating) the intermediate-code-data (for example, level data).

The ROM 34 stores font data, graphic functions or the like in addition to the controlling program (controlling routine) for carrying out various data-processing operations. The ROM 34 also stores various setting data for maintenance operations.

The controlling part 11 is adapted to carry out various controlling operations according to the controlling program stored in the ROM 34. For example, the controlling part 11 reads out the printing data from the receiving buffer, converts the printing data into the intermediate-code-data, and causes the intermediate buffer to store the intermediate-code-data. Then, the controlling part 11 analyzes the intermediate-code-data in the intermediate buffer and develops (decodes) the intermediate-code-data into the dot-pattern-data with reference to the font data and the graphic functions or the like stored in the ROM 34. Then, the controlling part 11 carries out necessary decorating operations to the dot-pattern-data, and thereafter causes the outputting buffer to store the dot-pattern-data.

When the dot-pattern-data corresponding to one line recorded by one main scanning of the recording head 4 are obtained, the dot-pattern-data are outputted to an electric driving system 39 of each head unit of the recording head 4 from the outputting buffer through the inside I/F 37 in turn. Then, the carriage 5 is moved in the main scanning direction, that is, the recording operation for the one line is conducted. When the dot-pattern-data corresponding to the one line are outputted from the outputting buffer, the intermediate-code-data that has been developed are deleted from the intermediate buffer, and the next developing operation starts for the next intermediate-code-data.

In addition, the controlling part 11 is adapted to control a maintenance operation (a recovering operation) conducted separately from the recording operation by the recording head 4.

In addition, the controlling part 11 is also adapted to control a preliminary operation for wetting the inside of the gear pump 15g. That is, the controlling part 11 is connected to the gear pump 15g to function as a preliminary-operation carrying-out part.

For the preliminary-operation control of the gear pump 15g by the controlling part 11, there are provided a timer 101 (an example of non-operating-time recognizing part as a state-quantity recognizing part) that measures a non-operating time Tn of the gear pump 15g, a standard-time setting part 102 (an example of standard-state-quantity setting part) in which a standard tine Ts (an example of standard state quantity) being a standard for carrying out the preliminary operation is set, and a judging part 103 that is adapted to judge that the inside of the gear pump 15g is dry, when the non-operating time Tn measured by the timer 101 is equal to or longer than the standard time Ts set in the standard-time setting part 102. Then, the controlling part 11 is adapted to carry out the preliminary operation for wetting the inside of the gear pump 15g when it is judged by the judging part 103 that the non-operating time Tn is equal to or longer than the shard time Ts, that is, when it is judged that the inside of the gear pump 15g is dry.

In the preliminary operation of the embodiment, a flushing operation of the ink is carried out from the recording head 4 to the capping member 15 in such a manner that a predetermined volume of the ink is ejected into the capping member 15, and then the gear pump 15g is caused to operate for a predetermined time.

The print engine 31 includes a paper feeding motor 13 as a paper feeding mechanism, a pulse motor 7 as a head scanning mechanism, and an electric driving system 39 of the recording head 4.

Then, the electric driving system 39 of the recording head 4 is explained. As shown in FIG. 7, the electric driving system 39 includes shift registers 40, latch circuits 41, level shifters 42 and switching units 43 and the piezoelectric vibrating members 21, which are electrically connected in the order. The shift registers 40 correspond to the respective nozzles 17, the latch circuits 41 correspond to the respective nozzles 17, the level shifters 42 correspond to the respective nozzles 17, and the switching units 43 correspond the respective nozzles 17, respectively. In addition, the piezoelectric vibrating members 21 also correspond to the respective nozzles 17 of the recording head 4, respectively.

In the electric driving system 39, when a selecting datum supplied to a switching unit 43 is “1”, the switching unit 43 is closed (connected) and the driving signal is directly supplied to a corresponding piezoelectric vibrating member 21. Thus, the piezoelectric vibrating member 21 deforms according to the signal-waveform of the driving signal. On the other hand, when a selecting datum supplied to a switching unit 43 is “0”, the switching unit 43 is opened (unconnected) and the driving signal is not supplied to a corresponding piezoelectric vibrating member 21.

As described above, based on the selecting data, the driving signal may be selectively supplied to each piezoelectric vibrating member 21. Thus, dependently on given selecting data, a drop of the ink may be jetted from a nozzle 17 or a meniscus of ink may be caused to minutely vibrate.

Next, an operation of the printer 1 is explained.

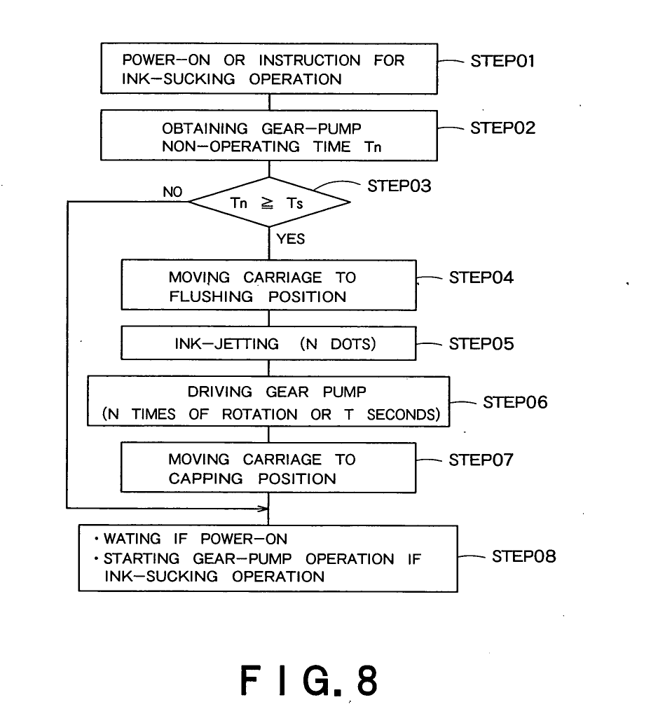

When electric power is supplied to the printer 1, a necessary initializing operation is conducted at first. In the embodiment, as shown in FIG. 8, as an initializing operation after the electric power has been supplied (STEP 01), a non-operating time Tn of the gear pump 15g is measured i.e. obtained by the timer 101 (STEP 02).

Then, the judging part 103 judges whether the obtained non-operating time Tn is equal to or longer than the standard time Ts set in the standard-time setting part 102 or not (STEP 03).

If the judge result is “No”, it is estimated (judged) that a wet state in the inside of the gear pump 15g is maintained, so that the state remains as a waiting state (STEP 08).

On the other hand, if the judge result is “Yes”, it is estimated (judged) that the inside of the gear pump 15g becomes dry to some extent, so that a preliminary operation is carried out by the controlling part 11. Specifically, via the control by the controlling part 11, the recording head 4 (the carriage 5) and the capping member 15 are moved to the flushing position (waiting position) (STEP 04). In that state, via the control by the controlling part 11, a predetermined volume of the ink, for example, N dots of the ink are jetted out by means of a flushing operation (STEP 05). Thus, the predetermined volume of the ink is ejected into the inside of the capping member 15. Then, the gear pump 15g is caused to operate n times of rotation or for t seconds (STEP 06). Thus, the ink ejected into the inside of the capping member 15 is conveyed into the inside of the gear pump 15g, so that the inside of the gear pump 15g is wetted, that is, returned to a wet state. Specifically, the gear pump 15g is returned to such a state that the gear pump 15g is able to provide a negative pressure greater than −5 kPa, preferably −15 kpa (The above n times of rotation or t seconds is set to satisfy this condition). Then, via the control by the controlling part 11, the recording head 4 (the carriage 5) an the capping member 15 are moved to the capping position (home position), and the recording head 4 is sealed by the capping member 15 (STEP 07). Then, the state remains as a waiting state (STEP 08).

After the initializing operation, when printing data corresponding to one line is outputted from the outputting buffer of the RAM 33, the recording head 4 conducts a maintenance operation (recovering operation) before a recording operation for the one line.

The maintenance operation is conducted for keeping ability of the recording head 4 to jet drops of the ink. The maintenance operation may be suitably selected from an ink-sucking operation, a flushing operation, a minutely-vibrating operation, and so on.

If the ink-sucking operation is conducted, as shown in FIG. 4B, the release-valve mechanism 15v is closed by the frame F or the like to seal the inside of the capping member 15, and thereafter the gear pump 15g is caused to operate. Then, the ink is sucked from the nozzles 17 of the recording head 4 by the gear pump 15g. At that time, since the gear pump 15g is caused to operate when there is a wet state in the inside of the gear pump 15g, the ink-sucking action can be satisfactorily assured.

After the maintenance operation is conducted, the recording operation is conducted in the objective recording area based on the printing data. Specifically, while the recording head 4 is moved in the main scanning direction, drops of the ink can be jetted from the nozzles 17 at respective suitable timings.

If the electric power continues to be supplied to the printer 1 for a long time, the maintenance operation may be conducted under certain conditions. If the ink-sucking operation is conducted as the maintenance operation for a case wherein the electric power continues to be supplied to the printer 1 for a long time, before the ink-sucking operation is conducted, the preliminary operation for the gear pump 15g is carried out when necessary.

The flowchart of the preliminary operation in the case is substantially the same as that just after the electric power has started to be supplied to the printer 1 (see FIG. 7). That is, after the instruction for the ink-sucking operation has been confirmed (STEP 01), a nonoperating time Tn of the gear pump 15g is measured i.e. obtained by the timer 101 (STEP 02).

Then, the judging part 103 judges whether the obtained non-operating time Tn is equal to or longer than the standard time Ts set in the standard-time setting part 102 or not (STEP 03).

If the judge result is “No”, it is estimated (judged) that a wet state in the inside of the gear pump 15g is maintained, so that the ink-sucking operation starts to be carried out under that state (STEP 08).

On the other hand, if the judge result is “Yes”, it is estimated that the inside of the gear pump 15g becomes dry to some extent, so that a preliminary operation is carried out by the controlling part 11. Specifically, via the control by the controlling part 11, the recording head 4 (the carriage 5) and the capping member 15 are moved to the flushing position (waiting position) (STEP 04). In that state, via the control by the controlling part 11, a predetermined volume of the ink, for example, N dots of the ink are jetted out by means of a flushing operation (STEP 05). Thus, the predetermined volume of the ink is ejected into the inside of the capping member 15. Then, the gear pump 15g is caused to operate n times of rotation or for t seconds (STEP 06). Thus, the ink ejected into the inside of the capping member 15 is conveyed into the inside of the gear pump 15g, so that the inside of the gear pump 15g is wetted, that is, returned to a wet state. Then, via the control by the controlling part 11, the recording head 4 (the carriage 5) and the capping member 15 are moved to the capping position (home position), and the recording head 4 is sealed by the capping member 15 (STEP 07). Thereafter, the ink-sucking operation starts to be carried out under that state (STEP 08).

As described above, according to the embodiment, the ink at the nozzles 17 can be sucked by the gear pump 15g that can be relatively easily designed optimally. On the other hand, the inside of the capping member 15 is communicated with the atmosphere via the release-valve mechanism 15v that is normally open, so that it is prevented that the menisci of the ink be broken down by air expansion/contraction caused by the temperature change or the like.

In addition, the preliminary operation for wetting the inside of the gear pump 15g is carried out only when the non-operating time Tn of the gear pump 15g is equal to or longer than the standard tine Ts. Thus, the inside of the gear pump 15g is efficiently returned to the wet state from the dry state.

In addition, according to the embodiment, the inside of the gear pump 15g is wetted with the ink. Thus, it is unnecessary to prepare a special wetting agent. Therefore, it is unnecessary to provide any mechanism for introducing a wetting agent, that is, the structure is simpler.

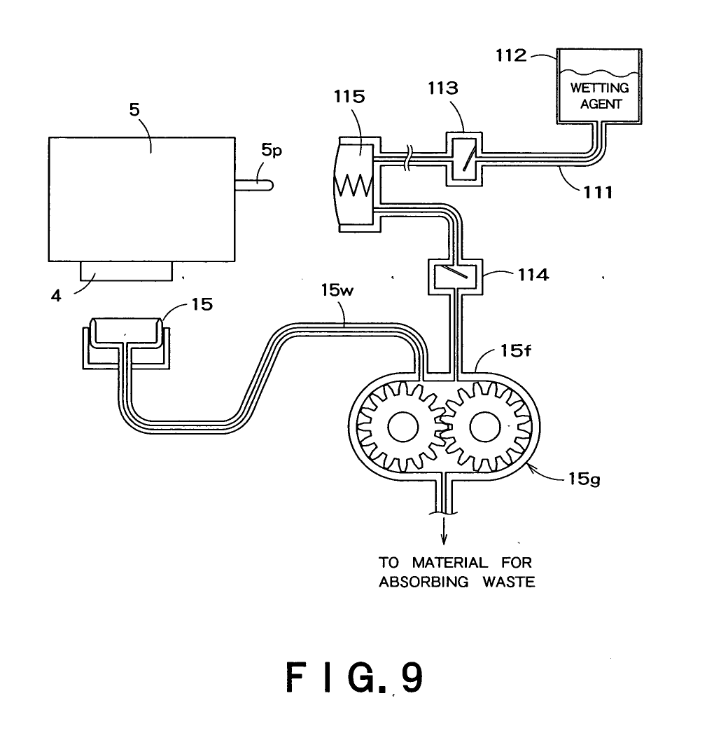

Next, FIG. 9 is a schematic sectional view of a gear pump and periphery thereof in an ink-jetting recording apparatus of a second embodiment according to the invention.

As shown in FIG. 9, a wetting-agent tank 112 is connected to the pump frame 15f of the gear pump 15g on the side of the capping member 15, via a wetting-agent supplying way 111. An optimum wetting agent is selected for optimally wetting the inside of the gear pump 15g, and the wetting-agent tank 112 is filled with the selected wetting agent.

Two check valves 113, 114 are provided on the way of the wetting-agent supplying way 111. A priming pump 115 is provided between the two check valves. The priming pump 115 is adapted to operate when the priming pump 115 itself is pushed. When the priming pump 115 operates, the wetting-agent is supplied from the wetting-agent tank 112 into the inside of the gear pump 15g.

In the embodiment, a pushing member 5p for pushing the priming pump 115 is formed on the carriage 5 integrated with the recording head 4. The pushing member 5b is adapted to push the priming pump 115 while the recording head 4 is moved in the main scanning direction, in order to cause the priming pump 115 to operate.

In addition, in the embodiment, the controlling part 11 is adapted not to cause the gear pump 15g to operate when the controlling part 11 functions as a preliminary-operation carrying-out part.

Other structure of the embodiment is substantially the same as the first embodiment explained with reference to FIGS. 1 to 8.

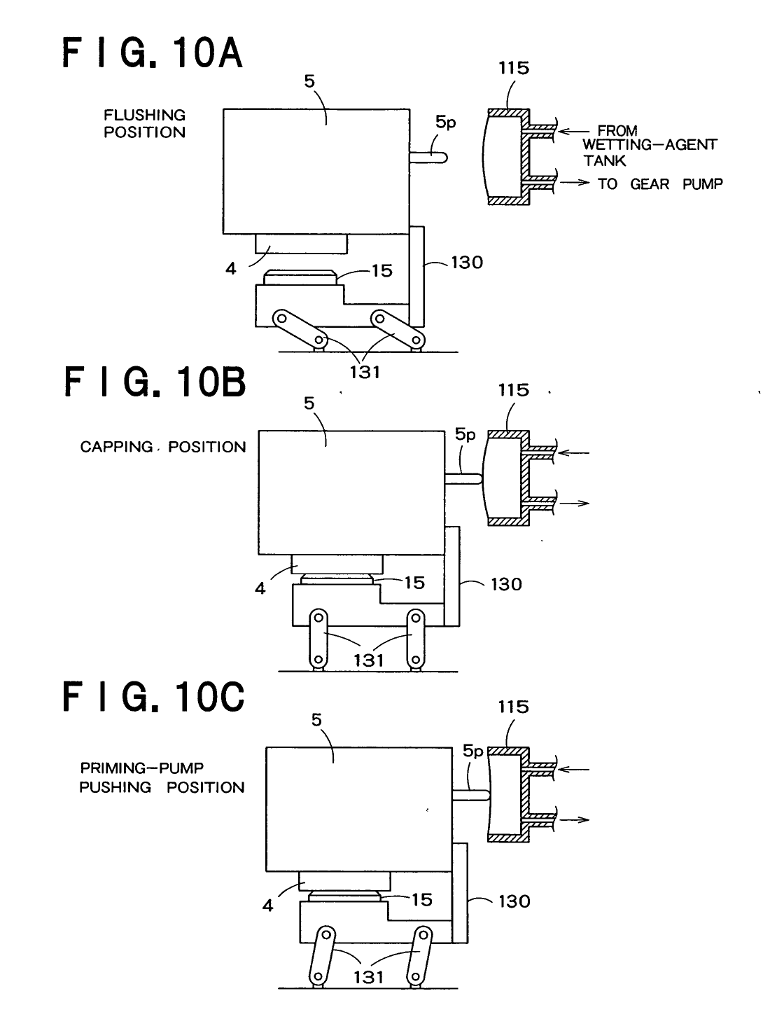

FIGS. 10A to 10C show an example of arrangement suited for the pushing member 5p to push the priming pump 115. In the example, a plate member 130 is provided to come in contact with the carriage 5, and the capping member 15 is movable while keeping a horizontal position via a parallel-linkage mechanism 131.

At the flushing position shown in FIG. 10A, the carriage 5 comes in contact with the plate member 130, but the pushing member 5p doesn't come in contact with the priming pump 115.

At the capping position shown in FIG. 10B, the carriage 5 pushes and moves the plate member 130 (and also slides vertically). Then, the capping member 15 is moved up by the parallel-linkage mechanism 131 to seal the recording head 4. At that time, the pushing member 5p comes in contact with the priming pump 115, but doesn't push the priming pump 115.

In order to cause the priming pump 115 to operate, as shown in FIG. 10C, the carriage 5 is further moved to the priming pump 115.

Herein, in order to effectively cause the priming pump 115 to operate, it is preferable to repeat the movement of the carriage 5 between the state shown in FIG. 10B and the state shown in FIG. 10C.

Next, an operation of the printer of the second embodiment is explained.

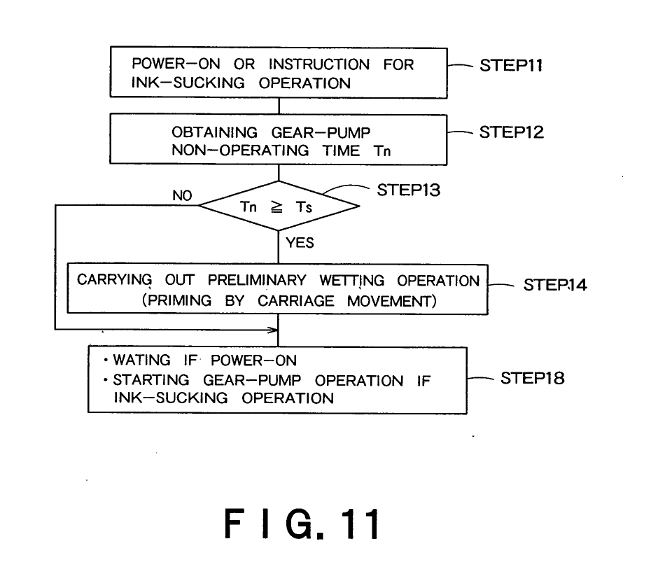

When electric power is supplied to the printer, a necessary initializing operation is conducted at first. In the embodiment, as shown in FIG. 11, as an initializing operation after the electric power has been supplied (STEP 11), a non-operating time Tn of the gear pump 15g is measured i.e. obtained by the timer 101 (STEP 12).

Then, the judging part 103 judges whether the obtained non-operating time Tn is equal to or longer than the standard time Ts set in the standard-time setting part 102 or not (STEP 13).

If the judge result is “No”, it is estimated (judged) that a wet state in the inside of the gear pump 15g is maintained, so that the state remains as a waiting state (STEP 18).

On the other hand, if the judge result is “Yes”, it is estimated (judged) that the inside of the gear pump 15g becomes dry to some extent, so that a preliminary operation is carried out by the controlling part 11 (STEP 13). Specifically, via the control by the controlling part 11, the recording head 4 (the carriage 5) is moved to cause the priming pump 115 to operate via the pushing member 5p. Thus, the wetting agent is supplied from the wetting-agent tank 112 into the inside of the gear pump 15g, so that the inside of the gear pump 15g is wetted, that is, returned to a wet state. Then, the state remains as a waiting state (STEP 18).

After the initializing operation, when printing data corresponding to one line is outputted from the outputting buffer of the RAM 33, the recording head 4 conducts a maintenance operation (recovering operation) before a recording operation for the one line.

The maintenance operation is conducted for keeping ability of the recording head 4 to jet drops of the ink. The maintenance operation may be suitably selected from an ink-sucking operation, a flushing operation, a minutely-vibrating operation, and so on.

If the ink-sucking operation is conducted, as shown in FIG. 4B, the release valve mechanism 15v is closed by the frame F or the like to seal the inside of the capping member 15, and thereafter the gear pump 15g is caused to operate. Then, the ink is sucked from the nozzles 17 of the recording head 4 by the gear pump 15g. At that time, since the gear pump 15g is caused to operate when there is a wet state in the inside of the gear pump 15g, the ink-sucking action can be satisfactorily assured.

After the maintenance operation is conducted, the recording operation is conducted in the objective recording area based on the printing data. Specifically, while the recording head 4 is moved in the main scanning direction, drops of the ink can be jetted from the nozzles 17 at respective suitable timings.

If the electric power continues to be supplied to the printer 1 for a long time, the maintenance operation may be conducted under certain conditions. If the ink-sucking operation is conducted as the maintenance operation for a case wherein the electric power continues to be supplied to the printer 1 for a long time, before the ink-sucking operation is conducted, the preliminary operation for the gear pump 15g is carried out when necessary.

The flowchart of the preliminary operation in the case is substantially the same as that just after the electric power has started to be supplied to the printer (see FIG. 10). Thus, the explanation is omitted.

According to the embodiment as well, the preliminary operation for wetting the inside of the gear pump 15g is carried out only when the non-operating time Tn of the gear pump 15g is equal to or longer than the standard time Ts. Thus, the inside of the gear pump 15g is efficiently returned to the wet state from the dry state.

In addition, according to the embodiment, the inside of the gear pump 15g is wetted with a special wetting agent, that is, an optimum wetting agent may be supplied at an optimum flow rate.

Herein, the manner of causing the priming pump to operate is not limited to the above one using the pushing member 5p, but also may be various other manners.

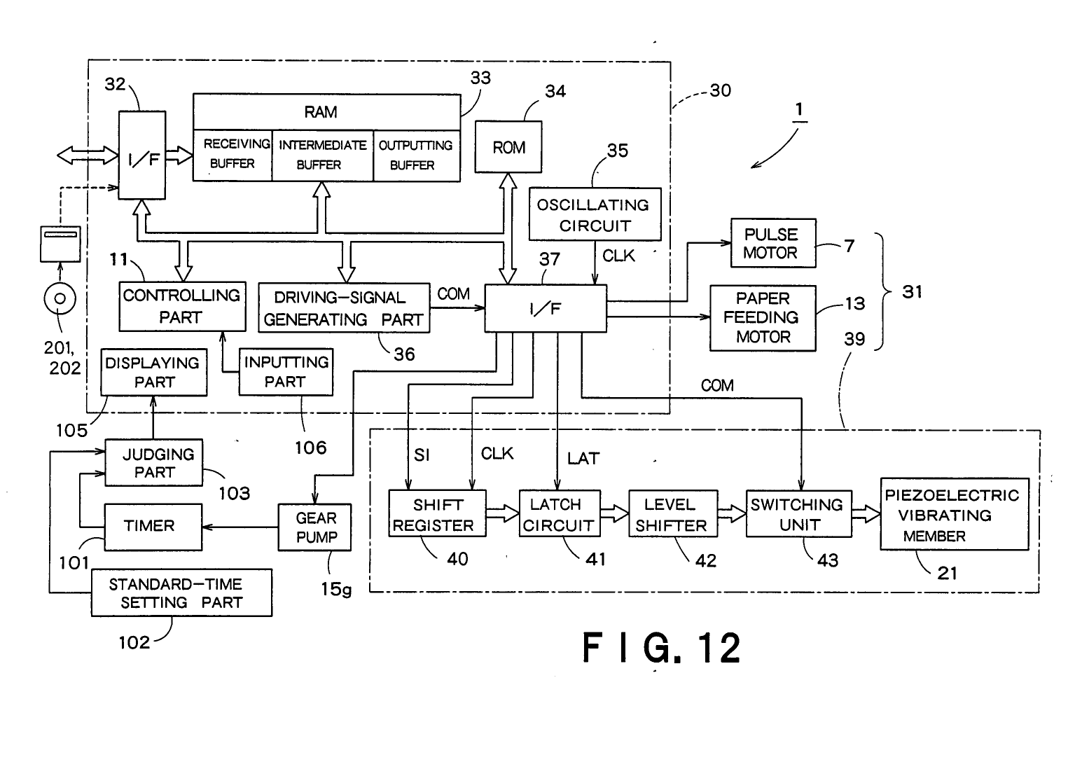

Next, FIG. 12 is a schematic block diagram for explaining an electric structure of an ink-jetting recording apparatus of a third embodiment according to the invention. In the above embodiments, the controlling unit 11 is adapted to automatically function as a preliminary-operation carrying-out part based on the judge result by the judging part 103. However, in the third embodiment, the controlling part 11 is adapted to function as a preliminary-operation carrying-out part after an instruction is inputted by a user.

That is, in the embodiment, as shown in FIG. 12, there are provided a displaying part 105 that displays judge result by the judging part 103, and an inputting part 106 into which a preliminary-operation instruction is manually inputted. In addition, the controlling part 11 is adapted to carry out a preliminary operation for wetting the inside of the gear pump 15g based on the preliminary-operation instruction inputted into the inputting part 106.

Other structure of the embodiment is substantially the same as the first embodiment explained with reference to FIGS. 1 to 8.

According to the third embodiment, when the non-operating time Tn of the gear pump 15g is equal to or longer than the standard time Ts, this information is displayed by the displaying part 105. Then, the user can estimate that the inside of the gear pump 15g becomes dry to some extent. Thus, by the user inputting the preliminary-operation instruction into the inputting part 106, the preliminary operation for wetting the inside of the gear pump 15g can be carried out efficiently.

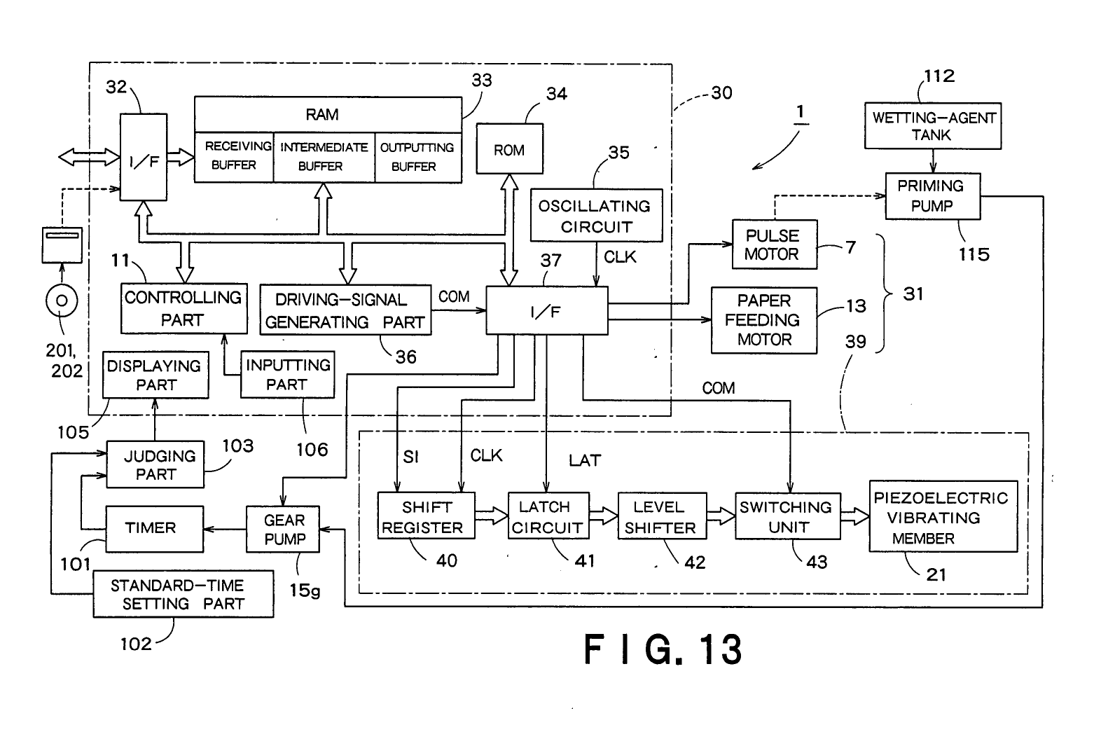

Next, FIG. 13 is a schematic block diagram for explaining an electric structure of an ink-jetting recording apparatus of a fourth embodiment according to the invention. In the fourth embodiment too, the controlling part 11 is adapted to function as a preliminary-operation carrying-out part after an instruction is inputted by a user.

That is, in the embodiment, as shown in FIG. 13, there are provided a displaying part 105 that displays judge result by the judging part 103, and an inputting part 106 into which a preliminary-operation instruction is manually inputted. In addition, the controlling part 11 is adapted to carry out a preliminary operation for wetting the inside of the gear pump 15g based on the preliminary-operation instruction inputted into the inputting part 106.

Other structure of the embodiment is substantially the same as the second embodiment explained with reference to FIGS. 9 to 11.

According to the fourth embodiment too, when the non-operating time Tn of the gear pump 15g is equal to or longer than the start time Ts, that information is displayed by the displaying part 105. Then, the user can estimte that the inside of the gear pump 15g becomes dry to some extent. Thus, by the user inputting the preliminary-operation instruction into the inputting part 106, the preliminary operation for wetting the inside of the gear pump 15g can be carried out efficiently.

If a manner not using the pushing member 5b is adopted as a manner of causing the priming pump 115 to operate, the priming pump 115 may be directly caused to operate by the preliminary-operation instruction.

In the above embodiments, the non-operating time Tn of the gear pump 15g is used as a state quantity related to the dry state in the inside of the gear pump 15g. However, a continuous open time of the capping member 15, an elapsed time in an OFF state of an electric power source, or the like may be used instead of the non-operating time Tn.

Alternatively, the state quantity related to the dry state in the inside of the gear pump 15g may be a state quantity related to an operating state of the gear pump 15 after the gear pump 15 g has been driven for a predetermined time.

Specifically, for example, as a state quantity related to an operating state of the gear pump 15g a pressure in the capping member 15 after the gear pump 15g has been driven for a predetermined time is used. If the pressure in the capping member 15 after the gear pump 15g has been driven for a predetermined time doesn't reach a predetermined negative pressure, it can be estimated that the inside of the gear pump 15g is in a dry state.

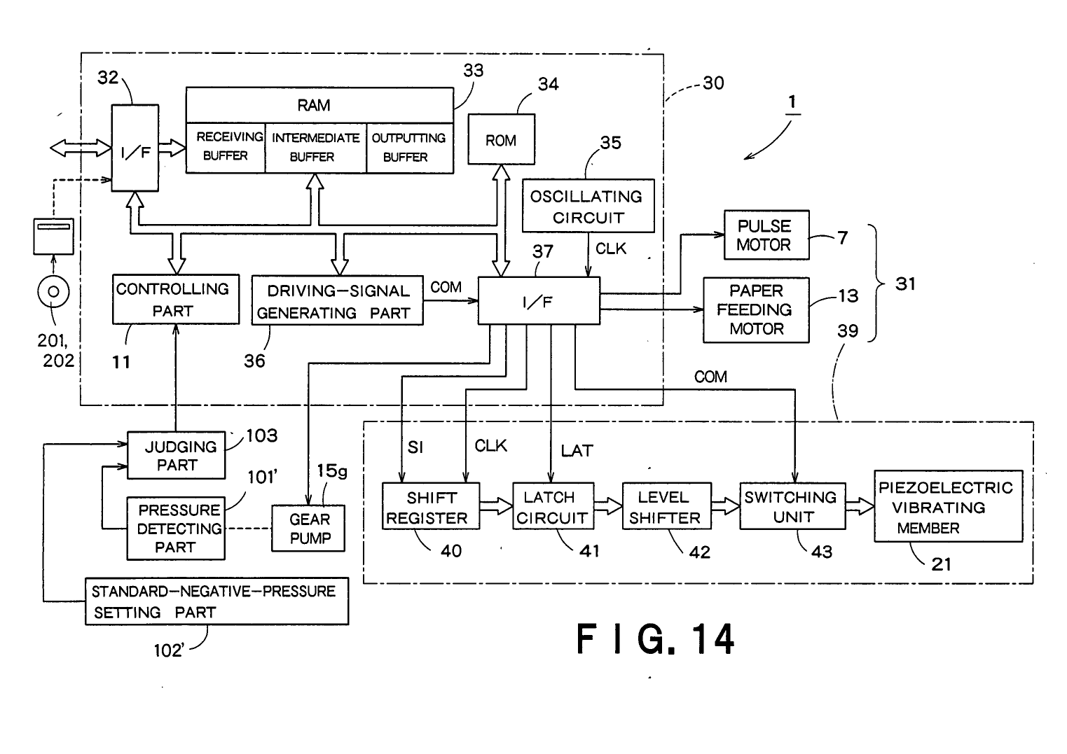

Such an embodiment is explained. FIG. 14 is a schematic block diagram for explaining an electric structure of an ink-jetting recording apparatus of a fifth embodiment according to the invention,

In the fifth embodiment, as a state-quantity recognizing part, a pressure detecting part 101′ is provided instead of the timer 101. For example, the pressure detecting part 101′ may consist of a film sensor or the like, and may be arranged in the suction way 15w from the capping member 15 or the inside of the capping member 15 to the gear pump 15g.

In addition, in the embodiment, as a standard-state-quantity setting part, a standard-negative-pressure setting part 102′, in which a standard negative pressure Ps being a standard for carrying out a preliminary operation is set, is provided instead of the standard-time setting part 102, in which the standard time Ts being a standard for carrying out a preliminary operation is set.

The judging part 103 is adapted to judge that the inside of the gear pump 15g is dry, when the pressure in the capping member Pn recognized by the pressure detecting part 101′ is equal to or above the standard negative pressure Ps set in tie standard-negative-pressure setting part 102′.

The controlling part 11 of the embodiment is adapted to cause the gear pump 15g to operate for a predetermined time in order to judge (estimate) the inside state of the gear pump 15g. Thereafter, when the judging part 103 judges that the pressure in the capping member Pn is equal to or above the standard negative pressure Ps (doesn't exceed the standard negative pressure Ps), that is, when the judging part 103 judges that the inside of the gear pump 15g is in a dry state, the controlling part 11 is adapted to carry out a preliminary operation for wetting the inside of the gear pump 15g.

Other structure of the embodiment is substantially the same as the first embodiment explained with reference to FIGS. 1 to 8.

Next, an operation of the printer of the fifth embodiment is explained.

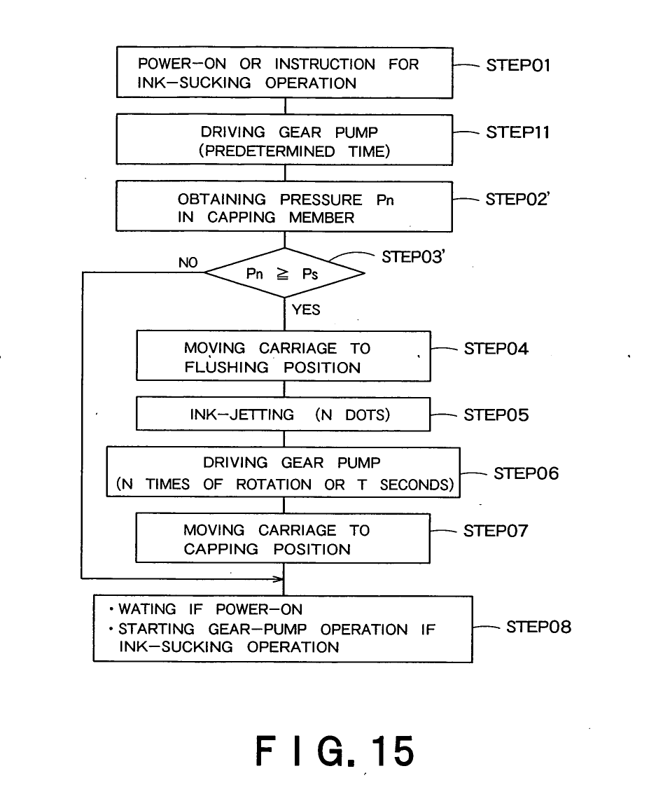

When electric power is supplied to the printer 1, a necessary initializing operation is conducted at first. In the embodiment, as shown in FIG. 15, as an initializing operation after the electric power has been supplied (STEP 01), the gear pump 15g is caused to operate for a predetermined time (STEP 11), and a pressure in the capping member Pn is measured i.e. obtained by the pressure detecting part 101′ (STEP 02′).

Then, the judging part 103 judges whether the obtained pressure in the capping member Pn is equal to or above the standard negative pressure Ps set in the standard-negative-pressure setting part 102′ or not (STEP 03′).

If the judge result is “No”, it is estinated (judged) that a wet state in the inside of the gear pump 15g is maintained, so that the state remains as a waiting state (STEP 08).

On the other hand, if the judge result is “Yes”, it is estimated (judged) that the inside of the gear pump 15g becomes dry to some extent, so that a preliminary operation is carried out by the controlling part 11. Specifically, via the control by the controlling part 11, the recording head 4 (the carriage 5) and the capping member 15 are moved to the flushing position (waiting position) (STEP 04). In that state, via the control by the controlling part 11, a predetermined volume of the ink, for example, N dots of the ink are jetted out by means of a flushing operation (STEP 05). Thus, the predetermined volume of the ink is ejected into the inside of the capping member 15. Then, the gear pump 15g is caused to operate n times of rotation or for t seconds (STEP 06). Thus, the ink ejected into the inside of the capping member 15 is conveyed into the inside of the gear pump 15g, so that the inside of the gear pump 15g is wetted, that is, returned to a wet state. Then, via the control by the controlling part 11, the recording head 4 (the carriage 5) and the capping member 15 are moved to the capping position (home position), and the recording head 4 is sealed by the capping member 15 (STEP 07). Then, the state remains as a waiting state (STEP 08).

After the initializing operation, when printing data corresponding to one line is outputted from the outputting buffer of the RAM 33, the recording head 4 conducts a maintenance operation (recovering operation) before a recording operation for the one line.

The maintenance operation is conducted for keeping ability of the recording head 4 to jet drops of the ink. The maintenance operation may be suitably selected from an ink-sucking operation, a flushing operation, a minutely-vibrating operation, and so on.

If the ink-sucking operation is conducted, as shown in FIG. 4B, the release-valve mechanism 15v is closed by the frame F or the like to seal the inside of the capping member 15, and thereafter the gear pump 15g is caused to operate. Then, the ink is sucked from the nozzles 17 of the recording head 4 by the gear pump 15g. At that time, since the gear pump 15g is caused to operate when there is a wet state in the inside of the gear pump 15g, the ink-sucking action can be satisfactorily assured.

After the maintenance operation is conducted, the recording operation is conducted in the objective recording area based on the printing data. Specifically, while the recording head 4 is moved in the main scanning direction, drops of the ink can be jetted from the nozzles 17 at respective suitable timings.

If the electric power continues to be supplied to the printer for a long time, the maintenance operation may be conducted under certain conditions. If the ink-sucking operation is conducted as the maintenance operation for a case wherein the electric power continues to be supplied to the printer 1 for a long time, before the ink-sucking operation is conducted, the preliminary operation for the gear pump 15g is carried out when necessary.

The flowchart of the preliminary operation in the case is substantially the same as that just after the electric power has started to be supplied to the printer 1 (see FIG. 15). That is, after the instruction for the ink-sucking operation has been confirmed (STEP 01), the gear pump 15g is caused to operate for a predetermined time (STEP 11), and a pressure in the capping member Pn is measured i.e. obtained by the pressure detecting part 101′ (STEP 02′).

Then, the judging part 103 judges whether the obtained pressure in the capping member Pn is equal to or above the standard negative pressure Ps set in the standard-negative-pressure setting part 102′ or not (STEP 03′).

If the judge result is “No”, it is estimated (judged) that a wet state in the inside of the gear pump 15g is maintained, so that the ink-sucking operation starts to be carried out under that state (STEP 08).

On the other hand, if the judge result is “Yes”, it is estimated that the inside of the gear pump 15g becomes dry to same extent, so that a preliminary operation is carried out by the controlling part 11. Specifically, via the control by the controlling part 11, the recording head 4 (the carriage 5) and the capping member 15 are moved to the flushing position (waiting position) (STEP 04). In that state, via the control by the controlling part 11, a predetermined volume of the ink, for example, N dots of the ink are jetted out by means of a flushing operation (STEP 05). Thus, the predetermined volume of the ink is ejected into the inside of the capping member 15. Then, the gear pump 15g is caused to operate n times of rotation or for t seconds (STEP 06). Thus, the ink ejected into the inside of the capping member 15 is conveyed into the inside of the gear pump 15g, so that the inside of the gear pump 15g is wetted, that is, returned to a wet state. Then, via the control by the controlling part 11, the recording head 4 (the carriage 5) and the capping member 15 are moved to the capping position (home position), and the recording head 4 is sealed by the capping mater 15 (STEP 07). Thereafter, the ink-sucking operation starts to be carried out under that state (STEP 08).

According to the embodiment, only when the pressure in the capping member Pn after the gear pump 15g has been driven for a predetermined time is equal to or above the standard negative pressure Ps, the preliminary operation for wetting the inside of the gear pump 15g can be carried out. Thus, in the case too, the inside of the gear pump 15g is efficiently returned to the wet state from the dry state.

Furthermore, as a state quantity related to an operating state of the gear pump 15g, a state quantity related to an ink flow after the gear pump 15g has been driven for a predetermined time way be also used. If an expected ink flow isn't generated after the gear pump 15g has been driven for a predetermined time, it can be estimated that the inside of the gear pump 15g is in a dry state. The state quantity related to an ink flow may be detected by a photon-interrupter provided in the suction way 15w, or an electrode provided in the capping member 15 or the gear pump 15g, or the like. In addition, an ink flow into the gear pump 15g may be detected, by detecting change in a rotational load of a motor (not shown) for driving the gear pump 15g from an electrical current waveform of the motor.

In addition, the gear pump is used in the above embodiments. However, instead of the gear pump, any roots pump, any quimby screw pump, any vane pump, or any other built-in slide-rotator type of positive displacement pump may be used.

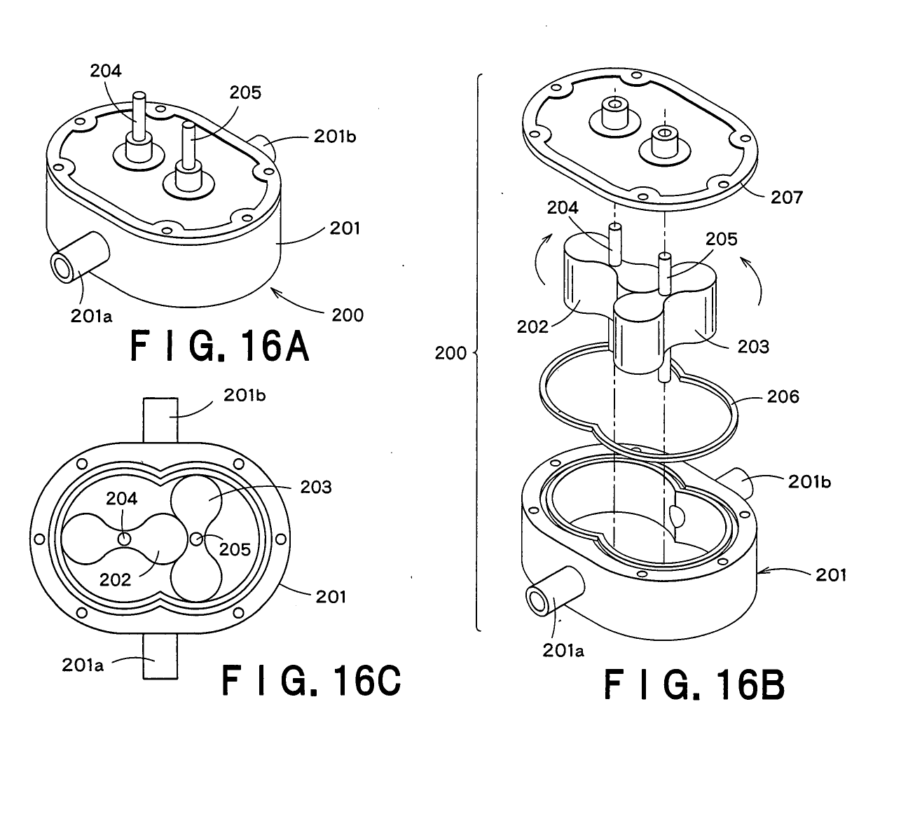

An example of structure of a roots pump is explained in detail with reference to FIGS. 16A to 16C. FIG. 16A is a perspective view of a roots pump 200, FIG. 16B is an exploded view of the roots pump 200, and FIG. 16C is a plan view of the roots pump 200 from which a lid 207 is removed.

As shown in FIGS. 16A to 16C, the roots pump 200 includes: a pump frame (casing) 201 having a suction port 201a connected to the suction way 15w; and a first rotator 202 and a second rotator 203 that are in a rolling contact with each other and that are contained in the pump frame 201. The first rotator 202 is rotated by means of a first driving shaft 204 that pierces the pump frame 201 and/or the lid 207. Similarly, the second rotator 203 is rotated by means of a second driving shaft 205 that pierces the pump frame 201 and/or the lid 207. The first driving shaft 204 and the second driving shaft 205 are arranged in parallel. The pump frame (casing) 201 is sealed by the lid 207 via a packing 206. In the example, the pump frame 201 has a discharging port 201b. The suction port 201a and the discharging port 201b are located opposite with respect to a slide area between the rotators 202, 203 and the pump frame 201.

For example, the roots pump 200 is formed in such a precise manner that a gap between the first and second rotators 202, 203 and the pump frame 201 is not more than 100 micron in both a radial direction and a thickness direction.

When the first rotator 202 and the second rotator 203 are synchronously rotated in a direction shown by arrows in FIG. 16B by the first driving shaft 204 and the second driving shaft 205, the first rotator 202 and the se rotator 203 slide on the pump frame 201 (via liquid (ink) menisci) while the first rotator 202 and the second rotator 203 roll on each other. Thus, the ink is conveyed from an IN area in the pump frame 201 (on the side of the suction port 201a) to an OUT area therein (on the side of the discharging port 201b) to achieve a pump function.

Herein, in the roots pump 200, the seal at the rolling area and the casing area can not be released, even if the rotational direction of the rotators is changed. That is, it is impossible for the In area and the OUT area to be communicated with each other to achieve an atmospheric release of the capping member 15. Therefore, for example, similarly to the case shown in FIGS. 4A and 4B, the release-valve mechanism 15v that is normally open may be provided at the capping member 15. The release-valve mechanism 15v is adapted to close only when the capping member 15 comes in contact with a frame F or the like, correspondingly to when it is necessary to suck the ink. Thus, the inside of the capping member 15 is normally communicated with the atmosphere, so that it is prevented the menisci are broken down by temperature change or the like, while the capping member 15 is suitably sealed when the ink has to be sucked.

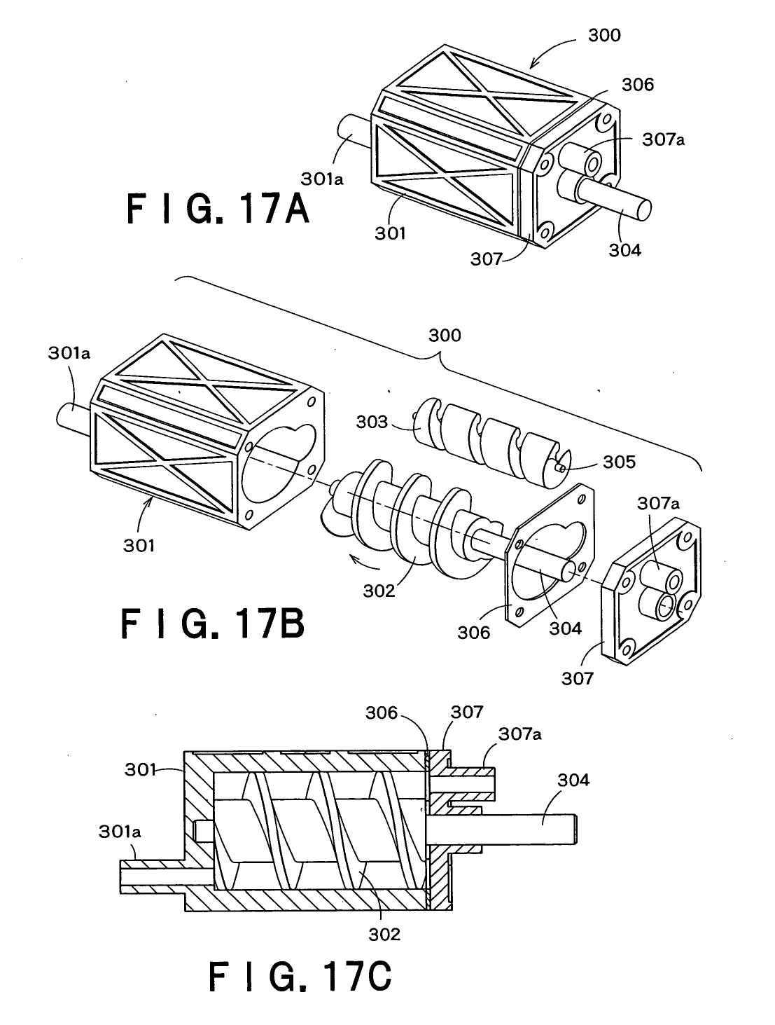

Next, an example of structure of a quimby screw pump is explained in detail with reference to FIGS. 17A to 17C. FIG. 17A is a perspective view of a quimby screw pump 300, FIG. 17B is an exploded view of the quimby screw pump 300, and FIG. 17C is a partial sectional view of the quimby screw pump 300.

As shown in FIGS. 17A to 17C, the quimby screw pump 300 includes: a pump frame (casing) 301 having a suction port 301a connected to the suction way 15w; and a driving spiral 302 and a driven spiral 303 that are engaged with each other and slidably contained in the pump frame 301 (via liquid (ink) menisci). The driving spiral 302 is rotated by means of a driving shaft 304 that pierces the pump frame 301 and/or a lid 307. The driven spiral 303 is pivotally supported by the pump frame 301 and the lid 307 via a driven shaft 305 that is parallel to the driving shaft 304. The pump frame (casing) 301 is sealed by the lid 307 via a packing 306. In the example, the lid 307 has a discharging port 307a. The suction port 301a and the discharging port 307a are located opposite with respect to a slide area between the spirals 302, 303 and the pump frame 301.

For example, the quimby screw pump 300 is formed in such a precise manner that a gap between the driving and driven spirals 302, 303 and the pump frame 301 is not more than 100 micron.

When the driving spiral 302 is rotated in a direction shown by an arrow in FIG. 17B by the driving shaft 304, the driven spiral 303 engaged with the driving spiral 302 is also rotated, so that the ink is conveyed from an IN area in the pump frame 301 (on the side of the suction port 301a) to an OUT area therein (on the side of the discharging port 307a) to achieve a pump function. Therefore, for example, similarly to the case shown in FIGS. 4A and 4B, the release-valve mechanism 15v that is normally open may be provided at the capping member 15. The release-valve mechanism 15v is adapted to close only when the capping member 15 comes in contact with a frame F or the like, correspondingly to when it is necessary to suck the ink. Thus, the inside of the capping member 15 is normally communicated with the atmosphere, so that it is prevented the menisci are broken down by temperature change or the iike, while the capping member 15 is suitably sealed when the ink has to be sucked.

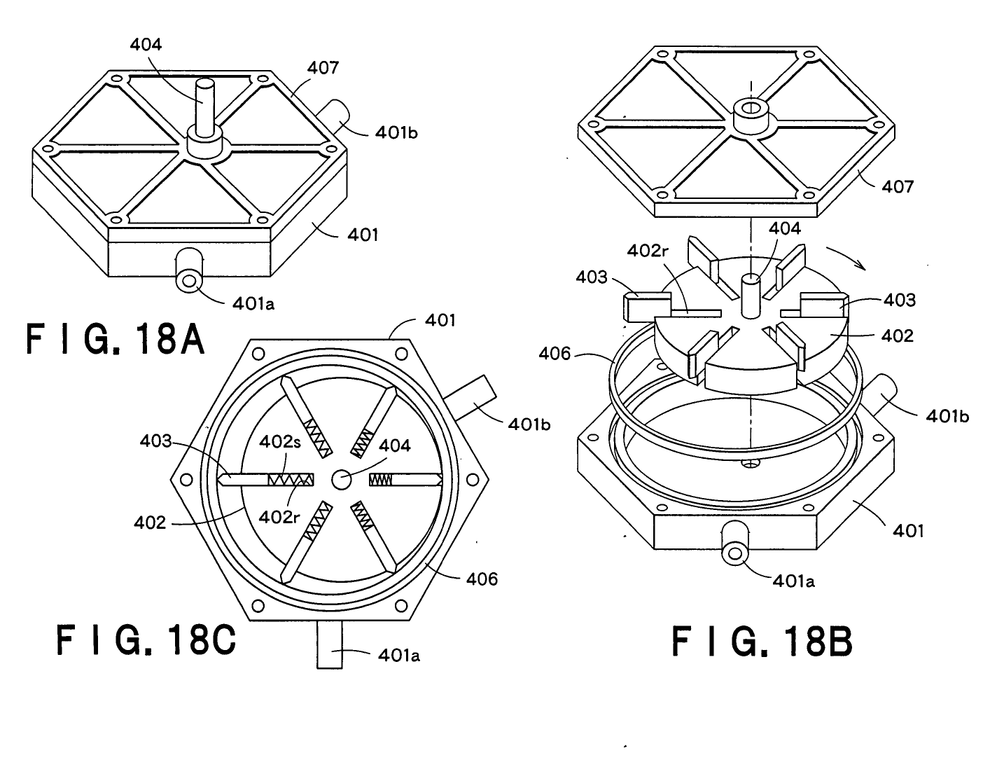

Next, an example of structure of a vane pump is explained in detail with reference to FIGS. 18A to 18C. FIG. 18A is a perspective view of a vane pump 400, FIG. 18B is an exploded view of the vane pump 400, and FIG. 16C is a plan view of the vane pump 400 from which a lid 407 is removed.

As shown in FIGS. 18A to 18C the vane pump 400 includes: a pump frame (casing) 401 having a suction port 401a connected to the suction way 15w; and a rotor 402 that is contained in the Pump frame 401. The rotor 402 has a cylindrical shape whose diameter is smaller than a diameter of a cylindrical space in the pump frame 401.

The rotor 402 is rotated by means of a driving shaft 404 that pierces the pump frame 401 and/or the lid 407. The driving shaft 404 is eccentrically located with respect to a center of the cylindrical space in the pump frame 401. A part of the outside periphery of the rotor 402 is adapted to slide on an inside surface of the pump frame 401 (via liquid (ink) menisci). A plurality of (six in the shown example) concave portions 402r is formed in the outside periphery of the rotor 402, at substantially even intervals in a circumferential direction thereof. A blade 403 is provided in each concave portion 402r via a spring 402s. The spring 402s provides a biasing force tending to move the blade 403 outwardly. The pump frame (casing) 401 is sealed by the lid 407 via a packing 406. In the example, the pump frame 401 has a discharging port 401b. The suction port 401a and the discharging port 401b are located in such a manner that a slide area between the rotor 402 and the pump frame 401 is sandwiched between the suction port 401a and the discharging port 401b.

For example, the vane pump 400 is formed in such a precise manner that a gap between the rotor 402 and the pump frame 401 is not more than 100 micron.

When the rotor 402 is rotated in a direction shown by an arrow in FIG. 18B by the driving shaft 404, by means of the blades 403 protruding from the rotor 402, the ink is conveyed from an IN area in the pump frame 401 (on the side of the suction port 401a) to an OUT area therein (on the side of the discharging port 401b) to achieve a pump function.

Herein, in the vane pump 400, the seal at the slide area can not be released, even if the rotational direction of the rotor 402 is changed. That is, it is impossible for the In area and the OUT area to he communicated with each other to achieve an atmospheric release of the capping member 15. Therefore, for example, similarly to the case shown in FIGS. 4A and 4B, the release-valve mechanism 15v that is normally open may be provided at the capping member 15. The release-valve mechanism 15v is adapted to close only when the capping member 15 comes in contact with a frame F or the like, correspondingly to when it is necessary to suck the ink. Thus, the inside of the capping member 15 is normally communicated with the atmosphere, so that it is prevented the menisci are broken down by temperature change or the like, while the capping member 15 is suitably sealed when the ink has to be sucked.

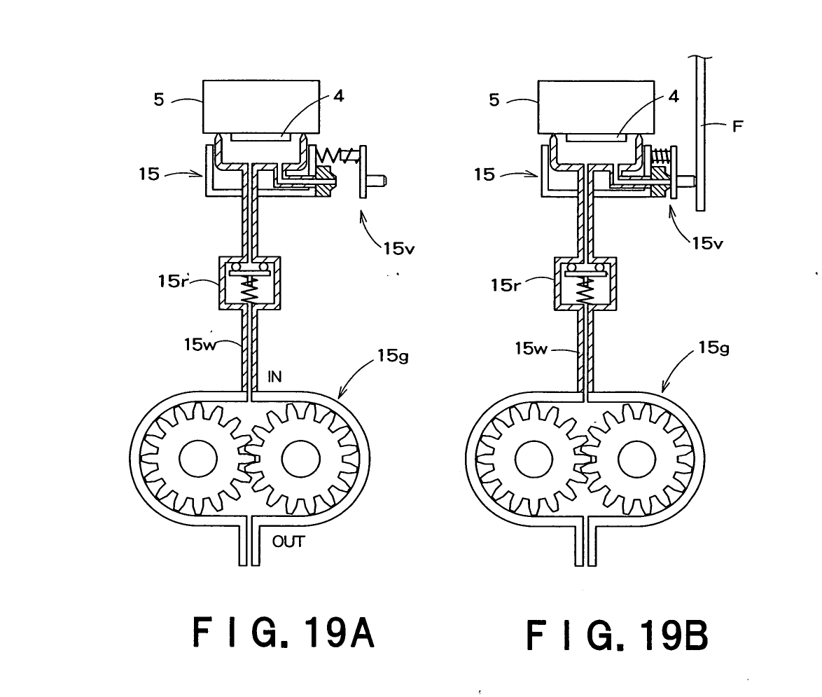

Regarding the above built-in slide-rotator type of positive displacement pumps, if precision of components thereof is low, when the sucking operation is stopped, the liquid seal in the pump may be break down at a time so that the atmospheric release may be advanced too fast. In such a case, air bubbles may enter the capping member and the nozzles to remarkably deteriorate the ink-jetting performance of the recording head. In the case, it is preferable to provide a check valve between the capping member 15 and the built-in slide-rotator type of positive displacement pump 15g, 200, 300 or 400. An embodiment including such a check valve 15r is shown in FIGS. 19A and 19B, correspondingly to FIGS. 4A and 4B.

In addition, instead of the built-in slide-rotator type of positive displacement pump like the gear pump, a reciprocating-mechanism type of positive displacement pump such as a piston pump, a bellows pump, a diaphragm pump or the like may be also used.

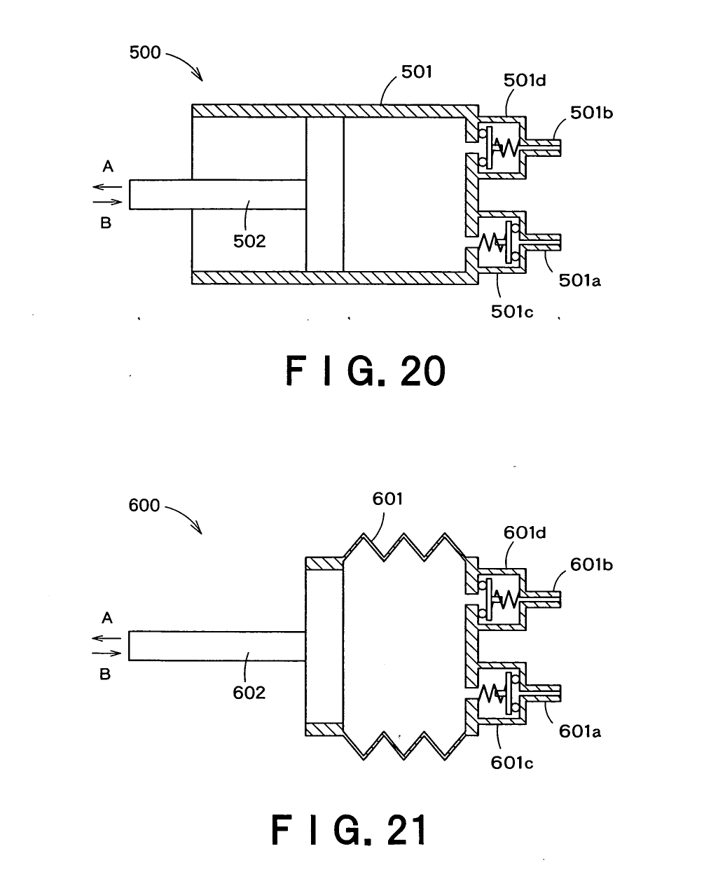

An example of structure of a piston pump is explained in detail with reference to FIG. 20. FIG. 20 is a schematic sectional view of a piston pump 500.

As shown in FIG. 20, the piston pump 500 includes a pump frame (cylinder) 501 whose volume is changeable by a reciprocating motion of a piston 502. A suction port 501a, which is connected to the suction way 15w, is formed at the pump frame 501 via a first check valve 501c. A discharging port 501b is also found at the pump frame 501 via a second check valve 501d.

When the piston 502 is moved in a direction shown by an arrow A in FIG. 20, the ink is introduced from the suction port 501a into the pump frame 501 through the first check valve 501c. At that time, the second check valve 501d is not opened, so that the ink is not introduced back through the discharging port 501b. Then, when the piston 502 is moved in a direction shown by an arrow B in FIG. 20, the ink is conveyed from the inside of the pump frame 501 to the discharging port 501b through the second check valve 501d. At that time, the first check valve 501c is not opened, so that the ink is not conveyed back to the suction port 501a. This reciprocating motion of the piston 502 is repeated, so that the ink is conveyed from an IN area in the pump frame 501 (on the side of the suction port 501a) to an OUT area therein (on the side of the discharging port 501b) to achieve a pump function.

Herein, in the piston pump 500, it is impossible for the In area and the OUT area to be communicated with each other to achieve an atmospheric release of the capping member 15. Therefore, for example, similarly to the case shown in FIGS. 4A and 4B, the release-valve mechanism 15v that is normally open may be provided at the capping member 15. The release-valve mechanism 15v is adapted to close only when the capping member 15 comes in contact with a frame F or the like, correspondingly to when it is necessary to suck the ink. Thus, the inside of the capping member 15 is normally communicated with the atmosphere, so that it is prevented the menisci are broken down by temperature range or the like, while the capping member 15 is suitably sealed when the ink has to be sucked.

Next, an example of structure of a bellows pump is explained in detail with reference to FIG. 21. FIG. 21 is a schematic sectional view of a bellows pump 600.

As shown in FIG. 21, the bellows pump 600 includes a bellows frame 601 whose volume is changeable by a reciprocating mechanism 602. A suction port 601a, which is connected to the suction way 15w, is formed at the bellows frame 601 via a first check valve 601c. A discharging port 601b is also formed at the bellows frame 601 via a second check valve 601d.

When the bellows frame 601 expands in a direction shown by an arrow A in FIG. 21, the ink is introduced from the suction port 601a into the bellows frame 601 through the first check valve 601c. At that time, the second check valve 601d is not opened, so that the ink is not introduced back through the discharging port 601b. Then, when the bellows frame 601 contracts in a direction shown by an arrow B in FIG. 21, the ink is conveyed from the inside of the bellows frame 601 to the discharging port 601b through the second check valve 601d. At that time, the first check valve 601a is not opened, so that the ink is not conveyed back to the suction port 601a. This expansion and contraction motion of the bellows foe 601 is repeated, so that the ink is conveyed from an IN area in the bellows frame 601 (on the side of the suction port 601a) to an OUT are therein (on the side of the discharging port 601b) to achieve a pump function.

Herein, in the bellows pump 600, it is impossible for the In area and the OUT area to be communicated with each other to achieve an atmospheric release of the capping member 15. Therefore, for example, similarly to the case shown in FIGS. 4A and 4B, the release-valve mechanism 15v that is normally open may be provided at the capping member 15. The release-valve mechanism 15v is adapted to close only when the capping member 15 comes in contact with a frame F or the like, correspondingly to when it is necessary to suck the ink. Thus, the inside of the capping member 15 is normally communicated with the atmosphere, so that it is prevented the menisci are broken down by temperature change or the like, while the capping member 15 is suitably sealed when the ink has to be sucked.

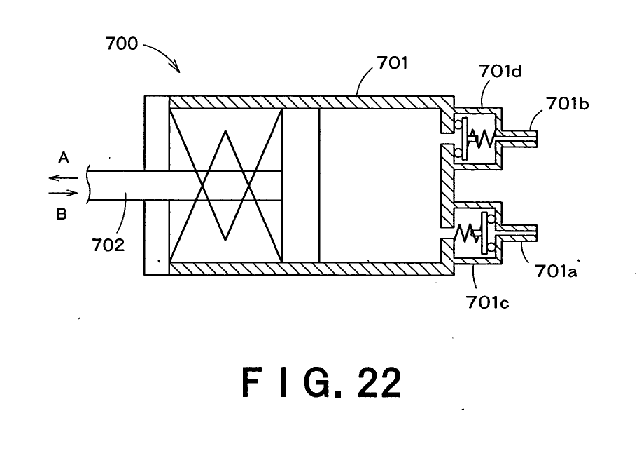

Next, an example of structure of a diaphragm pump is explained in detail with reference to FIG. 22. FIG. 22 is a schematic sectional view of a diaphragm pump 700.

As shown in FIG. 22, the diaphragm pump 700 includes a pump frame (cylinder) 701 whose volume is changeable by a reciprocating motion of a diaphragm 702. A suction port 701a, which is connected to the suction way 15w, is formed at the pump frame 701 via a first check valve 701c. A discharging port 701b is also formed at the pump frame 701 via a second check valve 701d.

When the diaphragm 702 is moved in a direction shown by an arrow A in FIG. 22, the ink is introduced from the suction port 701a into the pump frame 701 through the first check valve 701c. At that time, the second check valve 701d is not opened, so that the ink is not introduced back through the discharging port 701b. Then, when the diaphragm 702 is moved in a direction shown by an arrow B in FIG. 22, the ink is conveyed from the inside of the pump frame 701 to the discharging port 701b through the second check valve 701d. At that time, the first check valve 701c is not opened, so that the ink is not conveyed back to the suction port 701a. This reciprocating motion of the diaphragm 702 is repeated, so that the ink is conveyed from an IN area in the pump frame 701 (on the side of the suction port 701a) to an OUT area therein (on the side of the discharging port 701b) to achieve a pump function.

Herein, in the diaphragm pump 700, it is impossible for the In area and the OUT area to be communicated with each other to achieve an atmospheric release of the capping member 15. Therefore, for example, similarly to the case shown in FIGS. 4A and 4B, the release-valve mechanism 15v that is normally open may be provided at the capping member 15. The release-valve mechanism 15v is adapted to close only when the capping member 15 comes in contact with a frame F or the like, correspondingly to when it is necessary to suck the ink. Thus, the inside of the capping member 15 is normally communicated with the atmosphere, so that it is prevented the menisci are broken down by temperature change or the like, while the capping member 15 is suitably sealed when the ink has to be sucked.

In the above embodiments, the controlling part 11, the timer 101, the standard-time setting part 102, the judging part 103, and so on can be materialized by a computer system. A program for materializing the above one or more components in a computer system, and a storage unit 201 storing the program and capable of being read by a computer, are intended to be protected by this application.

In addition, when the above one or more components may be materialized in a computer system by using a general program such as an OS, a program including a command or for controlling the general program, and a storage unit 202 storing the program and capable of being read by a computer, are intended to be protected by this application.

Each of the storage units 201 and 202 can be not only a substantial object such as a floppy disk or the like, but also a network for transmitting various signals.

The above description is given for the ink-jetting printer as a liquid ejecting apparatus according to the invention. However, this invention is intended to apply to general liquid ejecting apparatuses widely. A liquid may be glue, nail polish, conductive liquid (liquid metal) or the like, instead of the ink. Furthermore, this invention can be applied to a manufacturing unit for color filters of a display apparatus such as LCD.

What is claimed is:

1. A liquid ejecting apparatus comprising:
a head member having a nozzle and a liquid-ejecting unit that ejects liquid in the nozzle,
a main controlling part that drives the liquid-ejecting unit based on ejecting data,
a capping member relatively movable between a position away from the head member and a position in contact with the head member,
a suction way communicated with an inside of the capping member,
a built-in slide-rotator type of positive displacement pump provided in the suction way,
a state-quantity recognizing part that recognizes a state quantity related to a dry state in an inside of the built-in slide-rotator type of positive displacement pump,
a standard-state-quantity setting part in which a standard state quantity is set, the standard state quantity being a standard for carrying out a preliminary operation for wetting the inside of the positive displacement pump,
a judging part that judges whether the inside of the positive displacement pump is dry or not, by comparing the state quantity recognized by the state-quantity recognizing part with the standard state quantity set in the standard-state-quantity setting part, and
a preliminary-operation carrying-out part that carries out the preliminary operation for wetting the inside of the positive displacement pump, when it is judged by the judging part that the inside of the positive displacement pump is dry.

2. A liquid ejecting apparatus comprising:
a head member having a nozzle and a liquid-ejecting unit that ejects liquid in the nozzle,
a main controlling part that drives the liquid-ejecting unit based on ejecting data,
a capping member relatively movable between a position away from the head member and a position in contact with the head member,
a suction way communicated with an inside of the capping member,
a built-in slide-rotator type of positive displacement pump provided in the suction way,
a state-quantity recognizing part that recognizes a state quantity related to a dry state in an inside of the built-in slide-rotator type of positive displacement pump,
a standard-state-quantity setting part in which a standard state quantity is set, the standard state quantity being a standard for carrying out a preliminary operation for wetting the inside of the positive displacement pump,
a judging part that judges whether the inside of the positive displacement pump is dry or not, by comparing the state quantity recognized by the state-quantity recognizing part with the standard state quantity set in the standard-state-quantity setting part,
a displaying part that displays judge result by the judging part,
an inputting part into which a preliminary-operation instruction is manually inputted, and
a preliminary-operation carrying-out part that carries out the preliminary operation for wetting the inside of the positive displacement pump, based on the preliminary-operation instruction inputted into the inputting part.

3. A liquid ejecting apparatus according to claim 1, wherein:
the preliminary-operation carrying-out part is adapted to cause the liquid-ejecting unit to eject liquid from the nozzle into the capping member, and thereafter drive the built-in slide-rotator type of positive displacement pump for a predetermined preliminary-operation time.

4. A liquid ejecting apparatus according to claim 1, wherein:
the built-in slide-rotator type of positive displacement pump has a pump frame connected to the suction way,
a wetting-agent supplying way for supplying a wetting agent is connected to the pump frame, and
the preliminary-operation carrying-out part is adapted to supply the wetting agent into the pump frame via the wetting-agent supplying way.

5. A liquid ejecting apparatus according to claim 4, wherein:
a priming pump is provided in the wetting-agent supplying way, and
the preliminary-operation carrying-out part is adapted to supply the wetting agent into the pump frame by causing the priming pump to operate.

6. A liquid ejecting apparatus according to claim 5, wherein:
the head member is integrated with a pushing member,
the pushing member is movable in a direction in such a manner that the pushing member can push the priming pump to cause the priming pump to operate, and
the preliminary-operation carrying-out part is adapted to supply the wetting agent into the pump frame by causing the priming pump to operate via the pushing member by moving the head member.

7. A liquid ejecting apparatus comprising:
a head member having a nozzle and a liquid-ejecting unit that ejects liquid in the nozzle,
a main controlling part that drives the liquid-ejecting unit based on ejecting data,
a capping member relatively movable between a position away from the head member and a position in contact with the head member,
a suction way communicated with an inside of the capping member,
a built-in slide-rotator type of positive displacement pump provided in the suction way,
a state-quantity recognizing part that recognizes a state quantity related to a dry state in an inside of the built-in slide-rotator type of positive displacement pump,
a standard-state-quantity setting part in which a standard state quantity is set, the standard state quantity being a standard for carrying out a preliminary operation for wetting the inside of the positive displacement pump,
a judging part that judges whether the inside of the positive displacement pump is dry or not, by comparing the state quantity recognized by the state-quantity recognizing part with the standard state quantity set in the standard-state-quantity setting part, and
a displaying part that displays judge result by the judging part,
wherein
the built-in slide-rotator type of positive displacement pump has a pump frame connected to the suction way,
a wetting-agent supplying way for supplying a wetting agent is connected to the pump frame,
a priming pump is provided in the wetting-agent supplying way, and
a manual inputting part for causing the priming pump to operate is connected to the priming pump.

8. A liquid ejecting apparatus according to claim 1, wherein:
the state quantity related to a dry state in an inside of the built-in slide-rotator type of positive displacement pump is a non-operating time of the positive displacement pump,
the state-quantity recognizing part is a non-operating-time recognizing part that recognizes the non-operating time,
the standard state quantity being a standard for carrying out a preliminary operation is a standard time being a standard for carrying out a preliminary operation,
the standard-state-quantity setting part is a standard-time setting part in which the standard time is set, and
the judging part is adapted to judge that the inside of the positive displacement pump is dry, when the non-operating time recognized by the non-operating-time recognizing part is equal to or longer than the standard time set in the standard-time setting part.

9. A liquid ejecting apparatus according to claim 1, wherein:
the state quantity related to a dry state in an inside of the built-in slide-rotator type of positive displacement pump is a state quantity related to an operating state of the positive displacement pump after the positive displacement pump has been driven for a predetermined time.

10. A liquid ejecting apparatus according to claim 1, wherein:
the built-in slide-rotator type of positive displacement pump is a gear pump.

11. A liquid ejecting apparatus according to claim 1, wherein:
the built-in slide-rotator type of positive displacement pump is a roots pump.

12. A liquid ejecting apparatus according to claim 1, wherein:
the built-in slide-rotator type of positive displacement pump is a quimby screw pump.

13. A liquid ejecting apparatus according to claim 1, wherein:
the built-in slide-rotator type of positive displacement pump is a vane pump.

14. A liquid ejecting apparatus comprising:
a head member having a nozzle and a liquid-ejecting unit that ejects liquid in the nozzle,
a main controlling part that drives the liquid-ejecting unit based on ejecting data,
a capping member relatively movable between a position away from the head member and a position in contact with the head member,
a suction way communicated with an inside of the capping member,
a reciprocating-mechanism type of positive displacement pump provided in the suction way,
a state-quantity recognizing part that recognizes a state quantity related to a dry state in an inside of the reciprocating-mechanism type of positive displacement pump,
a standard-state-quantity setting part in which a standard state quantity is set, the standard state quantity being a standard for carrying out a preliminary operation for wetting the inside of the positive displacement pump,
a judging part that judges whether the inside of the positive displacement pump is dry or not, by comparing the state quantity recognized by the state-quantity recognizing part with the standard state quantity set in the standard-state-quantity setting part, and
a preliminary-operation carrying-out part that carries out the preliminary operation for wetting the inside of the positive displacement pump, when it is judged by the judging part that the inside of the positive displacement pump is dry.

15. A liquid ejecting apparatus comprising:
a head member having a nozzle and a liquid-ejecting unit that ejects liquid in the nozzle,
a main controlling part that drives the liquid-ejecting unit based on ejecting data,
a capping member relatively movable between a position away from the head member and a position in contact with the head member,
a suction way communicated with an inside of the capping member,
a reciprocating-mechanism type of positive displacement pump provided in the suction way,
a state-quantity recognizing part that recognizes a state quantity related to a dry state in an inside of the reciprocating-mechanism type of positive displacement pump,
a standard-state-quantity setting part in which a standard state quantity is set, the standard state quantity being a standard for carrying out a preliminary operation for wetting the inside of the positive displacement pump,
a judging part that judges whether the inside of the positive displacement pump is dry or not, by comparing the state quantity recognized by the state-quantity recognizing part with the standard state quantity set in the standard-state-quantity setting part,
a displaying part that displays judge result by the judging part,
an inputting part into which a preliminary-operation instruction is manually inputted, and
a preliminary-operation carrying-out part that carries out the preliminary operation for wetting the inside of the positive displacement pump, based on the preliminary-operation instruction inputted into the inputting part.

16. A liquid ejecting apparatus according to claim 14, wherein:
the preliminary-operation carrying-out part is adapted to cause the liquid-ejecting unit to eject liquid from the nozzle into the capping member, and thereafter drive the reciprocating-mechanism type of positive displacement pump for a predetermined preliminary-operation time.

17. A liquid ejecting apparatus according to claim 14, wherein:
the reciprocating-mechanism type of positive displacement pump has a pump frame connected to the suction way,
a wetting-agent supplying way for supplying a wetting agent is connected to the pump frame, and
the preliminary-operation carrying-out part is adapted to supply the wetting agent into the pump frame via the wetting-agent supplying way.

18. A liquid ejecting apparatus according to claim 17, wherein:
a priming pump is provided in the wetting-agent supplying way, and
the preliminary-operation carrying-out part is adapted to supply the wetting agent into the pump frame by causing the priming pump to operate.

19. A liquid ejecting apparatus according to claim 18, wherein:
the head member is integrated with a pushing member,
the pushing member is movable in a direction in such a manner that the pushing member can push the priming pump to cause the priming pump to operate, and
the preliminary-operation carrying-out part is adapted to supply the wetting agent into the pump frame by causing the priming pump to operate via the pushing member by moving the head member.

20. A liquid ejecting apparatus comprising:
a head member having a nozzle and a liquid-ejecting unit that ejects liquid in the nozzle, p1 a main controlling part that drives the liquid-ejecting unit based on ejecting data,
a capping member relatively movable between a position away from the head member a position in contact with the head member,
a suction way communicated with an inside of the capping member,
a reciprocating-mechanism type of positive displacement pump provided in the suction way,
a state-quantity recognizing part that recognizes a state quantity related to a dry state in an inside of the reciprocating-mechanism type of positive displacement pump,
a standard-state-quantity setting part in which a standard state quantity is set, the standard state quantity being a standard for carrying out a preliminary operation for wetting the inside of the positive displacement pump,
a judging part that judges whether the inside of the positive displacement pump is dry or not, by comparing the state quantity recognized by the state-quantity recognizing part with the standard state quantity set in the standard-state-quantity setting part, and
a displaying part that displays judge result by the judging part,
wherein
the reciprocating-mechanism type of positive displacement pump has a pump frame connected to the suction way,
a wetting-agent supplying way for supplying a wetting agent is connected to the pump frame,
a priming pump is provided in the wetting-agent supplying way, and
a manual inputting part for causing the priming pump to operate is connected to the priming pump.

21. A liquid ejecting apparatus according to claim 14, wherein:
the state quantity related to a dry state in an inside of the reciprocating-mechanism type of positive displacement pump is a non-operating time of the positive displacement pump, the state-quantity recognizing part is a non-operating-time recognizing part that recognizes the non-operating time,
the standard state quantity being a standard for carrying out a preliminary operation is a standard time being a standard for carrying out a preliminary operation,
the standard-state-quantity setting part is a standard-time setting part in which the standard time is set, and
the judging part is adapted to judge that the inside of the positive displacement pump is dry, when the non-operating time recognized by the non-operating-time recognizing part is equal to or longer than the standard time set in the standard-time setting part.

22. A liquid ejecting apparatus according to claim 14, wherein:
the state quantity related to a dry state in an inside of the reciprocating-mechanism type of positive displacement pump is a state quantity related to an operating state of the positive displacement pump after the positive displacement pump has been driven for a predetermined time.

23. A liquid ejecting apparatus according to claim 14, wherein:
the reciprocating-mechanism type of positive displacement pump is a piston pump.

24. A liquid ejecting apparatus according to claim 14, wherein:
the reciprocating-mechanism type of positive displacement pump is a bellows pump.

25. A liquid ejecting apparatus according to claim 14, wherein:
the reciprocating-mechanism type of positive displacement pump is a diaphragm pump.

26. A controlling unit for controlling a liquid ejecting apparatus including: a head member having a nozzle and a liquid-ejecting unit that ejects liquid in the nozzle; a main controlling part that drives the liquid-ejecting unit based on ejecting data; a capping member relatively movable between a position away from the head member and a position in contact with the head member; a suction way communicated with an inside of the capping member; and a built-in slide-rotator type of positive displacement pump provided in the suction way; the controlling unit comprising
a state-quantity recognizing part that recognizes a state quantity related to a dry state in an inside of the built-in slide-rotator type of positive displacement pump,
a standard-state-quantity setting part in which a standard state quantity is set, the standard state quantity being a standard for carrying out a preliminary operation for wetting the inside of the positive displacement pump,
a judging part that judges whether the inside of the positive displacement pump is dry or not, by comparing the state quantity recognized by the state-quantity recognizing part with the standard state quantity set in the standard-state quantity setting part, and
a preliminary-operation carrying-out part that carries out the preliminary operation for wetting the inside of the positive displacement pump, when it is judged by the judging part that the inside of the positive displacement pump is dry.

27. A controlling unit according to claim 26, wherein:
the preliminary-operation carrying-out part is adapted to cause the liquid-ejecting unit to eject liquid from the nozzle into the capping member, and thereafter drive the built-in slide-rotator type of positive displacement pump for a predetermined preliminary-operation time.

28. A controlling unit according to claim 26, wherein:
the built-in slide-rotator type of positive displacement pump has a pump frame connected to the suction way,
a wetting-agent supplying way for supplying a wetting agent is connected to the pump frame, and
the preliminary-operation carrying-out part is adapted to supply the wetting agent into the pump frame via the wetting-agent supplying way.

29. A controlling unit according to claim 28, wherein:
a priming pump is provided in the wetting-agent supplying way, and
the preliminary-operation carrying-out part is adapted to supply the wetting agent into the pump frame by causing the priming pump to operate.

30. A controlling unit according to claim 29, wherein:
the head member is integrated with a pushing member,
the passing member is movable in a direction in such a manner that the pushing member can push the priming pump to cause the priming pump to operate, and
the preliminary-operation carrying-out part is adapted to supply the wetting agent into the pump frame by causing the priming pump to operate via the pushing member by moving the head member.

31. A controlling unit according to claim 26, wherein:
the state quantity related to a dry state in an inside of the built-in slide-rotator type of positive displacement pump is a non-operating time of the positive displacement pump,
the state-quantity recognizing part is a non-operating-time recognizing part that recognizes the non-operating time,
the standard state quantity being a standard for carrying out a preliminary operation is a standard time being a standard for carrying out a preliminary operation,
the standard-state-quantity setting part is a standard-time setting part in which the standard time is set, and
the judging part is adapted to judge that the inside of the positive displacement pump is dry, when the non-operating time recognized by the non-operating-time recognizing part is equal to or longer than the standard time set in the standard-time setting part.

32. A controlling unit according to claim 26, wherein:
the state quantity related to a dry state in an inside of the built-in slide-rotator type of positive displacement pump is a state quantity related to an operating state of the positive displacement pump after the positive displacement pump has been driven for a predetermined time.

33. A controlling unit for controlling a liquid ejecting apparatus including: a head member having a nozzle and a liquid-ejecting unit that ejects liquid in the nozzle; a main controlling part that drives the liquid-ejecting unit based on ejecting data; a capping member relatively movable between a position away from the head member and a position in contact with the head member; a suction way communicated with an inside of the capping member; and a reciprocating-mechanism type of positive displacement pump provided in the suction way; the controlling unit comprising
a state-quantity recognizing part that recognizes a state quantity related to a dry state in an inside of the reciprocating-mechanism type of positive displacement pump,
a standard-state-quantity setting part in which a standard state quantity is set, the standard state quantity being a standard for carrying out a preliminary operation for wetting the inside of the positive displacement pump,
a judging part that judges whether the inside of the positive displacement pump is dry or not, by comparing the state quantity recognized by the state-quantity recognizing part with the standard state quantity set in the standard-state-quantity setting part, and
a preliminary-operation carrying-out part that carries out the preliminary operation for wetting the inside of the positive displacement pump, when it is judged by the judging part that the inside of the positive displacement pump is dry.

34. A controlling unit according to claim 33, wherein:
the preliminary-operation carrying-out part is adapted to cause the liquid-ejecting unit to eject liquid from the nozzle into the capping member, and thereafter drive the reciprocating-mechanism type of positive displacement pump for a predetermined preliminary-operation time.

35. A controlling unit according to claim 33, wherein:
the reciprocating-mechanism type of positive displacement pump has a pump frame connected to the suction way,
a wetting-agent supplying way for supplying a wetting agent is connected to the pump frame, and
the preliminary-operation carrying-out part is adapted to supply the wetting agent into the pump frame via the wetting-agent supplying way.

36. A controlling unit according to claim 35, wherein:
a priming pump is provided in the wetting-agent supplying way, and
the preliminary-operation carrying-out part is adapted to supply the wetting agent into the pump frame by causing the priming pump to operate.

37. A controlling unit according to claim 36, wherein:
the head member is integrated with a pushing member,
the pushing member is movable in a direction in such a manner that the pushing member can push the priming pump to cause the priming pump to operate, and
the preliminary-operation carrying-out part is adapted to supply the wetting agent into the pump frame by causing the printing pump to operate via the pushing member by moving the head member.

38. A controlling unit according to claim 33, wherein:
the state quantity related to a dry state in an inside of the reciprocating-mechanism type of positive displacement pump is a non-operating time of the positive displacement pump,
the state-quantity recognizing part is a non-operating-time recognizing part that recognizes the non-operating time,
the standard state quantity being a standard for carrying out a preliminary operation is a standard time being a standard for carrying out a preliminary operation,
the standard-state-quantity setting part is a standard-time setting part in which the standard time is set, and
the judging part is adapted to judge that the inside of the positive displacement pump is dry, when the non-operating time recognized by the non-operating-time recognizing part is equal to or longer than the standard time set in the standard-time setting part.

39. A controlling unit according to claim 33, wherein:
the state quantity related to a dry state in an inside of the reciprocating-mechanism type of positive displacement pump is a state quantity related to an operating state of the positive displacement pump after the positive displacement pump has been driven for a predetermined time.

40. A program being executed by a computer system including at least a computer to materialize a controlling unit for controlling a liquid ejecting apparatus including: a head member having a nozzle and a liquid-ejecting unit that ejects liquid in the nozzle; a main controlling part that drives the liquid-ejecting unit based on ejecting data; a capping member relatively movable between a position away from the head member and a position in contact with the head member; a suction way communicated with an inside of the capping member; and a built-in slide-rotator type of positive displacement pump provided in the suction way; the controlling unit comprising
a state-quantity recognizing part that recognizes a state quantity related to a dry state in an inside of the built-in slide-rotator type of positive displacement pump,
a standard-state-quantity setting part in which a standard state quantity is set, the standard state quantity being a standard for carrying out a preliminary operation for wetting the inside of the positive displacement pump,
a judging part that judges whether the inside of the positive displacement pump is dry or not, by comparing the state quantity recognized by the state-quantity recognizing part with the standard state quantity set in the standard-state-quantity setting part, and
a preliminary-operation carrying-out part that carries out the preliminary operation for wetting the inside of the positive displacement pump, when it is judged by the judging part that the inside of the positive displacement is dry.

41. A program being executed by a computer system including at least a computer to materialize a controlling unit for controlling a liquid ejecting apparatus including: a head member having a nozzle and a liquid-ejecting unit that ejects liquid in the nozzle; a main controlling part that drives the liquid-ejecting unit based on ejecting data; a capping member relatively movable between a position away from the head member and a position in contact with the head member; a suction way communicated with an inside of the capping member; and a reciprocating-mechanism type of positive displacement pump provided in the suction way; the controlling unit comprising
a state-quantity recognizing part that recognizes a state quantity related to a dry state in an inside of the reciprocating-mechanism type of positive displacement pump,
a standard-state-quantity setting part in which a standard state quantity is set, the standard state quantity being a standard for carrying out a preliminary operation for wetting the inside of the positive displacement pump,
a judging part that judges whether the inside of the positive displacement pump is dry or not, by comparing the state quantity recognized by the state-quantity recognizing part with the standard state quantity set in the standard-state-quantity setting part, and
a preliminary-operation carrying-out part that carries out the preliminary operation for wetting the inside of the positive displacement pump, when it is judged by the judging part that the inside of the positive displacement pump is dry.

42. A program including a command for controlling a second program executed by a computer system including at least a computer, the program being executed by the computer system to control the second program to materialize a controlling unit for controlling a liquid ejecting apparatus including: a head member having a nozzle and a liquid-ejecting unit that ejects liquid in the nozzle; a main controlling part that drives the liquid-ejecting unit based on ejecting data; a capping relatively movable between a position away from the head member and a position in contact with the head member; a suction way communicated with an inside of the capping member; and a built-in slide-rotator type of positive displacement pump provided in the suction way; the controlling unit comprising
a state-quantity recognizing part that recognizes a state quantity related to a dry state in an inside of the built-in slide-rotator type of positive displacement pump,
a standard-state-quantity setting part in which a standard state quantity is set, the standard state quantity being a standard for carrying out a preliminary operation for wetting the inside of the positive displacement pump,
a judging part that judges whether the inside of the positive displacement pump is dry or not, by comparing the state quantity recognized by the state-quantity recognizing part with the standard state quantity set in the standard-state-quantity setting part, and
a preliminary-operation carrying-out part that carries out the preliminary operation for wetting the inside of the positive displacement pump, when it is judged by the judging part that the inside of the positive displacement pump is dry.

43. A program including a command for controlling a second program executed by a computer system including at least a computer, the program being executed by the computer system to control the second program to materialize a controlling unit for controlling a liquid ejecting apparatus including: a head member having a nozzle and a liquid-ejecting unit that ejects liquid in the nozzle; a main controlling part that drives the liquid-ejecting unit based on ejecting data; a capping member relatively movable between a position away from the head member and a position in contact with the head member; a suction way communicated with an inside of the capping member; and a reciprocating-mechanism type of positive displacement pump provided in the suction way; the controlling unit comprising
a state-quantity recognizing part that recognizes a state quantity related to a dry state in an inside of the reciprocating-mechanism type of positive displacement pump,
a standard-state-quantity setting part in which a standard state quantity is set, the standard state quantity being a standard for carrying out a preliminary operation for wetting the inside of the positive displacement pump,
a judging part that judges whether the inside of the positive displacement pump is dry or not, by comparing the state quantity recognized by the state-quantity recognizing part with the standard state quantity set in the standard-state-quantity setting part, and
a preliminary-operation carrying-out part that carries out the preliminary operation for wetting the inside of the positive displacement pump, when it is judged by the judging part that the inside of the positive displacement pump is dry.

44. A method of controlling a liquid ejecting apparatus including: a head member having a nozzle and a liquid-ejecting unit that ejects liquid in the nozzle; a main controlling part that drives the liquid-ejecting unit based on ejecting data; a capping member relatively movable between a position away from the head member and a position in contact with the head member; a suction way communicated with an inside of the capping member; and a built-in slide-rotator type of positive displacement pump provided in the suction way; the method comprising
a step of recognizing a state quantity related to a dry state in an inside of the built-in slide-rotator type of positive displacement pump,
a step of judging whether the inside of the positive displacement pump is dry or not, by comparing the state quantity related to a dry state in an inside of the built-in slide-rotator type of positive displacement pump with a standard state quantity that has been set in advance, and
a step of carrying out a preliminary operation for wetting the inside of the positive displacement pump, when it is judged that the inside of the positive displacement pump is dry.

45. A method of controlling a liquid ejecting apparatus including: a head member having a nozzle and a liquid-ejecting unit that ejects liquid in the nozzle; a main controlling part that drives the liquid-ejecting unit based on ejecting data; a capping member relatively movable between a position away from the head member and a position in contact with the head member; a suction way communicated with an inside of the capping member; and a reciprocating-mechanism type of positive displacement pump provided in the suction way; the method comprising
a step of recognizing a state quantity related to a dry state in an inside of the reciprocating-mechanism type of positive displacement pump,
a step of judging whether the inside of the positive displacement pump is dry or not, by comparing the state quantity related to a dry state in an inside of the reciprocating-mechanism type of positive displacement pump with a standard state quantity that has been set in accordance, and
a step of carrying out a preliminary operation for wetting the inside of the positive displacement pump, when it is judged that the inside of the positive displacement pump is dry.
